(19) United States
(12) Patent Application Publication
(10) Pub. No.: US 2021/0026911 A1
(43) Pub. Date: Jan. 28, 2021

(54) INFORMATION CONNECTION METHOD AND APPARATUS BASED ON ENTITY INFORMATION HOUSES

(71) Applicant: Yi Yang, Beijing (CN)

(72) Inventors: Yi Yang, Beijing (CN); Can Yang, Hengyang (CN)

(21) Appl. No.: 16/996,983

(22) Filed: Aug. 19, 2020

Related U.S. Application Data
(63) Continuation-in-part of application No. PCT/CN2019/075303, filed on Feb. 17, 2019.

(30) Foreign Application Priority Data
Feb. 24, 2018 (CN) 201810155920.9

(51) Int. Cl. G06F 16/9536; G06F 16/9537; G06F 16/9535; H04L 12/58; G06Q 20/38

(52) U.S. Cl. CPC G06F 16/9536; G06F 16/9537; G06Q 50/01; H04L 51/12; G06Q 20/384; G06F 16/9535

(57) ABSTRACT

The present application provides an information connection method and apparatus based on entity information houses, comprising one or more types of information components and information application methods between the information components. The information connection method and device of the present application mainly divide and establish information spaces and information houses according to people's real life environment and social organization structures, so that it can display maps of various scopes and properties for users' navigation to retrieve information houses, and people can complete various information connections based on the information houses.

### CROSS REFERENCES TO RELATED APPLICATIONS

The present application is a continuation-in-part application of the PCT patent application numbered PCT/CN2019/075303, titled “ENTITY TYPE INFORMATION PORTAL-BASED INFORMATION CONNECTION METHOD AND APPARATUS”, filed in the World Intellectual Property Organization on Feb. 17, 2019.

The PCT patent application claims the priority of the Chinese patent application numbered 201810155920.9, titled “ENTITY TYPE INFORMATION PORTAL-BASED INFORMATION CONNECTION METHOD AND APPARATUS”, filed to the Chinese Patent Office on Feb. 24, 2018, all contents of which is incorporated hereby reference.

### FIELD

The present application relates to electronics and internet technology field, and particularly to an information connection method and apparatus based on entity information houses.

### BACKGROUND

Currently, website and APP products on the internet are developing rapidly. After the earliest house websites, mainstream products can be divided into business service information classification products and social products. Business service information classification products can further be divided into two types: vertical single and comprehensive. However social products are currently trying to break the boundaries between themselves and commerce.

The rapid development of these internet products is of course to meet people's requirement and driven by people's requirement.

However, there are still many situations where people's requirement is met. that is, the requirement is not realized, or the requirement is not satisfied. Therefore, there are still many practical problems, which can be listed, caused by the lack of suitable products.

The problems are mainly as follows:

first, the problem of online shopping around.

For example, in such a scenario, we hope to purchase goods online from a store near where we reside. Certainly, there are many O2O products now, but O2O products still can only serve high-frequency purchased and large-category goods, and low-frequency purchased and small-category products are abandoned by the O2O APP. Only in this way there will be profitable for the O2O APP.

Second, the problem of information classification search.

Sometimes, the product categories of what you want to purchase are not clear. As a result, it is difficult to find them on a large shopping website or shopping APP. Sometimes, there are regional requirements for the required information. However, most products now provide search functions that do not have such a region dimension, so even if the region characteristics of certain information are known, it still cannot find them out.

Third, the problem of effective social contact.

There are two types of the problems of effective social contact in current social products: one is public service social contact. Community organizations or police departments often require to release some community activity information, policy information, and safety information, while community residents want to report some problems and seek some services. Currently, there are no good methods to satisfy this type of social contact.

Fourth, the problem of the degree of business involvement.

Many businesses can now be broken down into a crowd plus processes or scenarios. However, for today's for social contact products, processes or scenarios are abandoned after abstracting the crowd into a group. As a result, this kind of business involvement is unsatisfactory.

Fifth, problems of event or activity social contact.

Some major events or activities, such as flood disaster events, marathon races, bicycle races surrounding city or lake or alongside riverside, etc. The information about these events or activities is obtained from media reports, or from friends, but the information is often not enough, or not expected.

### SUMMARY

In order to partially solve the above problems, the present application provides an information connection method and apparatus based on entity information houses.

In the method and apparatus of the present application, the introduced information components and information spaces are all collections or sets of related information, but in different context and/or target object, it will be more reasonable for expressions to use different names. The display of information components and information spaces on the device includes but is not limited to interfaces UI, pages, windows, information lists, information boxes, information combined areas or sectors.

Entity information houses is a type of information component. The “entity” includes physicality and/or sociality. The “physicality” includes locations or spaces. The “sociality” includes social organization or social unit or social events. A set of methods and devices can further be called a system.

In this description, the entity information houses are simply called information houses.

Entity information houses include but are not limited to corresponding entity information houses of studios and/or companies and/or factories and/or schools and/or hospitals and/or stores or supermarkets and/or hotels and/or restaurants and/or office buildings and/or squares and/or parks and/or stations and/or airports and/or stadiums/gyms and/or golf courses and/or autodrome/velodrome and/or basketball court/football field and/or entertainment venues and/or libraries and/or museums and/or scenic areas or scenic spots and/or playgrounds and/or film and television bases and/or cinemas/theatres and/or television stations and/or roads and/or railway lines and/or subway lines and/or mountains and/or rivers and/or lakes and/or residential community and/or streets and/or blocks and/or urban areas and/or cities and/or natural geography areas and/or town and/or villages and/or police offices or police stations. Schools include kindergartens and/or primary schools and/or junior high schools and/or senior high schools and/or universities and/or vocational colleges and/or training institutions. Companies can include tiny or personal studios. Roads include but are not limited to highways and/or railways.

Entity information houses can further include entity information houses corresponding to villages and/or towns and/or counties and/or cities and/or provinces and/or countries.

The entity information houses can further include event information houses. Event information houses include but are not limited to corresponding entity information houses of earthquakes and/or wind disasters and/or fire disasters and/or floods and/or accidents and hot events. Occurrence of events always have impacts on society and events always occur in certain locations and spaces. Accidents include but are not limited to traffic accidents, building or facility collapse and safety impact accidents.

The entity information houses can further include activity information houses. Activity information houses include but are not limited to corresponding physical information houses of temple fairs and/or marathons and/or bicycle races and/or ball games and/or concerts and/or rallies and/or sports meetings and/or opening ceremonies and/or graduation ceremonies and/or and weddings. Activities have a certain social significance and always occur in a certain location and space.

Entity information houses further include but are not limited to the above entity information houses, subordinate entity information houses which are divided based on geographic features and/or orientation features and/or architectural features and/or organizational structure features or usage features, or more subordinate entity information houses which are divided progressively. In other words, there are superior or subordinate relationships between related entity information houses.

Entity information houses further include but are not limited to corresponding entity information houses of neighborhood committees and/or community organizations and/or ball game fan associations and/or car clubs and/or chambers of commerce and/or industry associations and/or charity organizations and/or animal protection organizations and/or academic or technical organizations and/or art or cultural organizations and/or education management departments. These organizations have both social significance and physical office spaces.

Entity information houses can further include entity information houses based on the management organization node. Similarly, these organizational nodes have both social significance and physical office spaces.

Entity information houses include all their information houses and information in the information houses. An information house can be divided into many subordinate information houses according to actual applications. It is difficult to express exhaustively all the information houses included in the actual information houses. Therefore, in the expression, an information houses can be referred to as itself in its name, simply called itself/themselves, or as any one of its subordinate information houses.

As mentioned-above, an information house is divided into a series of information houses, and when the information house in the name needs to refer to one of its subordinate information houses, it needs a concept of a basic information house for expressing its internal superior information houses. It can be judged from the context that the first definition of “XXX Information houses” is the basic information house, such as “school canteen or restaurant information houses”, the basic information house of which is “school”, or “road information houses”, the basic information house of which is “Road”. In the later explain text, some supplementary explanations also can be added to specify that an information house is a “basic information house” in the current context.

Superior information houses of an information house include an internal superior information houses and an external superior information houses with the basic information house as the boundary. The internal superior information houses of an information house include all or part of the information houses from itself to the basic information house, but do not include itself. The external superior information houses do not include the basic information house.

Entity information houses in specific division of application areas can be smaller than the actual area or larger than the actual area or include the surrounding environment due to application requirements.

The present application includes one or more types of information components and information application modes based on interiors of the information components and between the information components;

the information components include entity information houses and be able to include map information spaces, and/or index collection information spaces of the entity information houses, and/or article information spaces, and/or user groups;

the map information spaces or the article information spaces is included in the entity information houses or not;

the information application modes include entry modes of the entity information houses, and/or two of the user groups forming an association relationship, and/or the user groups and the entity information houses forming association relationships, and/or two of the entity information houses forming an association relationship, and/or building the user groups which at least comprise one of users and user group;

the entity information houses include one or more of interactive information spaces and/or situation information spaces and/or announcement information spaces and/or commodity or service display information spaces and/or map information spaces and/or article information spaces and/or live broadcast information spaces;

the entry modes of the entity information houses include an entry mode of the users selecting marks on a map to enter, and/or an entry mode of the users selecting target entity information houses from the index collection information spaces of the entity information houses to enter and/or an entry mode of the users to enter through index of the entity information houses associated with the user groups, and/or an entry mode of the users to enter through marks related to the entity information houses and added to articles, and/or an entry mode of the users to enter via device positioning. The “selecting” is the same as “by”/“through”/“via”.

All types of information components and all types of information spaces are information collections/sets. Map information spaces and article information spaces are contained in the entity information houses, which can be called information spaces. If they are independent of the entity information houses, they can be called information components.

Interactive information spaces include but are not limited to bulletin boards and/or chat rooms. The situation information spaces include but are not limited to pictures, and/or videos and/or article information. The announcement information spaces include but are not limited to announcement information. The commodity or service information spaces include but are not limited to commodity and/or service information.

The map information spaces include but are not limited to maps. Maps include but are not limited to electronic maps and/or alike maps. The alike maps include but are not limited to analog maps, and/or schematic maps and/or structure maps. The analog maps is used for including facilities or buildings or shapes that need to be drawn intricately. The schematic maps are used for including simply draught directions or shapes. The structure maps are used for including drafting structure maps or simple buildings or simple shapes or organization charts.

The article information spaces include but are not limited to articles and article indexes.

The live broadcast information spaces realize live broadcast functions.

The users enter the entity information houses by device positioning, and the areas of the current information houses entered by the users include the current location information of the users' devices. When the location of a device is covered by multiple information houses, the user can select one function from the information house list, or the system can assigns one function to the user by default.

In this description, all expressions of “through XXX” or “by XXX” or “via XXX” or “selecting XXX” include one or more information operation processes.

In this description, sending information to on-site users of the information houses includes but is not limited to sending messages and/or announcements and/or requests for uploading pictures or videos. Reward information can be added to the information. On-site users uploading pictures or videos to the information houses can get rewards.

In this description, the users upload pictures or videos to the information houses, and the holder where the pictures or videos are “stored” includes but is not limited to the situation information spaces of the information houses. The user groups are the abbreviation of user chat groups. In other words, the user chat groups are simply called user groups.

This application further includes but is not limited to the following series of features.

It can include but is not limited to, marking the entity information houses on maps, and the users entering target information houses by selecting marks of the entity information houses on the maps, the entity information houses in the context indicate one or more entity information houses of all entity information houses, and so on.

It can include but is not limited to, uploading pictures and videos by management role users or authorized users of store or restaurant or company or factory information houses; marking the pictures and videos on outer-maps of the information houses; browsing or commenting the pictures or videos, and/or entering the information houses by the users selecting target marks thereof. The outer-maps of the entity information houses mean that the maps aren't interior of the information houses, or aren't contained in the information houses, but are exterior thereof, and inner-maps and out-maps are opposite. Entity information houses marked on the outer-maps include but are not limited to the entity information houses. Companies can include tiny or personal studios. Marks of pictures or videos on the maps include but are not limited to thumbnail marks or animation or moving pictures. The users can browse or comment pictures or videos, and/or enter target information houses, and/or can enter pictures or videos information spaces, by the marks of pictures or videos on the maps. The pictures or videos information spaces include but are not limited to pictures and videos. The pictures or videos spaces can be considered as the prelude information spaces included in the target information houses. Management roles' users of the information houses include but are not limited to the owner, and/or operator, and/or manager of the information houses.

It can include but is not limited to, pictures or videos can be uploaded by on-site users of the entity information houses, and/or the pictures or videos can be marked on the inner-maps or outer-maps of the information houses.

It can include but is not limited to, locations, marked on the maps, of pictures or videos uploaded by the users being corresponded to locations of users who upload or locations information contained in the pictures or videos.

It can include but is not limited to, user groups forming association relationships with the entity information houses, and members of the user groups being able to become authorized users of the entity information houses. User roles operating information in entity information houses include, but are not limited to, management roles' users, authorized users and non-authorized users. The privileges of the management roles' users includes the management and configuration of the information houses. The privilege of non-authorized users includes totally unable to operate information in the information houses, or allowable to operate public information. Authorized users can operate different scopes of non-public information according to different privileges and roles. Of course, authorized users can include operating public information.

Operation information in the entity information houses includes but is not limited to browsing information and/or editing information, and/or downloading or saving information and/or purchasing or payment information operation and/or sending information and/or uploading articles or pictures or videos or file information and/or interacting in the interactive information spaces and/or interacting with their associated user groups and/or entering their superior or subordinate information houses to continuously operate information and/or entering their associated information houses to continuously operate information. Sending information includes but is not limited to sending comments and/or messages and/or emoticons and/or further includes reward information.

Interaction with user groups associated with the entity information houses includes but is not limited to, sending information to the user groups, entering the user group to browse and/or leave a message and/or participate in a chat, and entering the entity information houses associated with the user groups to operate information.

Sending information to the user groups includes but is not limited to, sending information to information spaces of the user groups, and sending information to designated members of groups.

Sending information to the information houses includes but is not limited to, able to send information to the information houses even if without entering there, and/or further to their associated user groups.

It can include but is not limited to, user groups forming association relationships with the entity information houses, and an index of one of the user groups and the entity information houses at least being existed in an information space of the other of the user groups and the entity information houses. The Index includes but is not limited to shortcut information, and/or link information, and/or index item and/or label information.

It can include but is not limited to, user groups forming association relationships with entity information houses, and members of the user groups being able to enter the entity information houses by indexes of the entity information houses in the user groups.

It can include but is not limited to, family user groups being able to associate with one or more types of the entity information houses. Members of family user groups include but are not limited to users of family members. Information application modes of the user groups to associate with the entity information houses include but are not limited to, members of the user groups sending association application information to the entity information houses, and/or the management roles' users or authorized users of the entity information houses inviting the user groups for association, and then the two ultimately forming an association relationship after the application or invitation is allowed. Sending association application modes by members of the user groups to the entity information houses includes but is not limited to operation processes of searching by keywords or identifying information encoding of the entity information houses. The information encoding of the entity information houses includes but is not limited to information bar code or QR code.

It can include but is not limited to, family user groups being able to associate with hotel or restaurant information houses. The hotel information houses include themselves, and can further include but are not limited to, information houses divided according to the hotel orientation or architectural or usage characteristics and/or hotel square information houses and/or hotel lobby information houses and/or hotel restaurant information houses and/or hotel conference hall information houses and/or hotel stores information houses and/or hotel guest room information houses and/or hotel fitness venue information houses. The hotel information houses can further include subordinate entity information houses further divided according to requirements. Usage characteristics include but are not limited to, function usages and/or organization management usages. Organization management usages include but are not limited to, corresponding organization nodes usages and management function usages. Restaurant information houses include themselves and/or further include but are not limited to, information houses divided according to the restaurants' orientation, architectural or usage characteristics, and/or further include subordinate entity information houses further divided according to requirements.

It can include but is not limited to, family user groups being able to associate with church information houses. The church information houses include themselves, and can further include but are not limited to, information houses divided according to church orientation or architectural or usage characteristic and/or church square information houses and/or auditorium information houses. Church information houses can further include subordinate entity information houses further divided according to requirements.

It can include but is not limited to, family user groups being able to associate with scenic area or scenic spot information houses. Scenic areas or scenic spots information houses include themselves, and can further include but are not limited to, information houses according to scenic areas or scenic spots orientation or architectural or usage characteristics and/or scenic areas or scenic spots square information houses and/or scenic areas or scenic spots road information houses and/or scenic areas or scenic spots restaurants information houses, and/or scenic areas or scenic spots store information houses, and/or scenic areas or scenic spots facility information houses. Scenic areas or scenic spots information houses can further include subordinate entity information houses further divided according to requirements.

It can include but is not limited to, family user groups being able to associate with pet shop information houses. The pet shop information houses includes themselves, and can further include but are not limited to, information houses divided according to pet shops orientation or architectural or usage characteristics. The pet shop information house can further include subordinate entity information houses further divided according to requirements.

It can include but is not limited to, family user groups being able to associate with hospital information houses. The hospital information houses include themselves, but can further include but are not limited to, information houses divided according to hospitals orientation or architectural or usage characteristics, and/or hospital square information houses, and/or hospital hall information houses, and/or hospital department information houses, and/or hospital inpatient buildings or ward information houses, and/or hospital store information houses, and/or hospital restaurant information houses. Hospital information houses can further include subordinate entity information houses further divided according to requirements.

It can include but is not limited to, family user groups being able to associate with hospital inpatient building or ward information houses. The hospital inpatient buildings or ward information houses include themselves, and can further include but are not limited to, information houses divided according to hospital inpatient buildings or ward orientation or architectural or usage characteristics. Hospital inpatient buildings or wards Information houses can further include subordinate entity information houses further divided according to requirements.

It can include but is not limited to, family user groups being able to associate with hospital department information houses. The hospital department information houses include themselves, and can further include but are not limited to, information houses divided according to hospital inpatient building or ward orientation or architectural or usage characteristics. Hospital inpatient buildings or wards information houses can further include subordinate entity information houses further divided according to requirements.

It can include but is not limited to, doctor or nurse user groups being able to associate with hospital information houses. Members of the doctor or nurse user groups include but are not limited to, doctors or nurses. Members of the doctor or nurse user groups can become authorized users of hospital information houses.

It can include but is not limited to, doctor or nurse user groups being able to associate with hospital department information houses.

It can include but is not limited to, doctor or nurse user groups being able to associate with hospital inpatient building or ward information houses.

It can include but is not limited to, family user groups being able to associate with store or supermarket information houses. The store or supermarket information houses include themselves, and can further include but are not limited to, information houses divided according to store or supermarket orientation or architectural or commodity classification or usage characteristics, and can further include subordinate entity information houses further divided according to requirements.

It can include but is not limited to, family user groups being able to associate with school information houses. The school information houses include themselves, and can further include but are not limited to, information houses divided according to the school orientation or architectural or usage characteristics, and/or school square information houses, and/or school road information houses, and/or school store information houses, and/or school canteen or restaurant information houses, schools library information houses, and/or school sports venue information houses, and/or school teaching building or classroom information houses, and/or school dormitory information houses, and/or school bulletin board information houses, and/or school class information houses. All above school information houses can further include subordinate entity information houses subordinate entity information houses further divided according to requirements. Information houses divided according to usage characteristics of schools include but are not limited to departmental information houses of schools. Management department information houses of schools include but are not limited to principal office information houses and academic affairs office information houses. Members of family user groups can become authorized users of school information houses.

It can include but is not limited to, family user groups being able to associate with class information houses. The class information houses include themselves, and can further include subordinate entity information houses according to requirements. Members of family user groups can become authorized users of class or school information houses.

It can include but is not limited to, family user groups being able to associate with residential community information houses. The residential community houses include themselves, and can further include but are not limited to, information houses divided according to residential community orientation or architectural or usage characteristics. Residential community square information houses, and/or residential community road information houses, and/or residential community store information houses, and/or residential community activity venue information houses, and/or residential building information houses, and/or family household information houses. Residential community information houses can further include subordinate entity information houses further divided according to requirements. Activity venue information houses include but are not limited to basketball court information houses, and/or tennis court information houses, and/or fitness venue information houses, and/or squares, chess or mahjong or playing cards room information houses. Members of family user groups can become authorized users of residential community information houses.

It can include but is not limited to, family user groups being able to associate with family household information houses. The family household information houses include themselves, and can further include subordinate entity information house further divided according to requirement. Members of family user groups can become authorized users of family household information houses or residential community information houses.

It can include but is not limited to, alumnus user groups being able to associate with school information houses. Members of alumnus user groups include but are not limited to, students who have left schools, teachers and staff. Members of alumnus user groups can become authorized users of school information houses.

It can include but is not limited to, class user groups being able to associate with class or classroom or teaching building or school information houses. Members of class user groups include but are not limited to, students who are in class together for a period of time, and/or students in the same year, and/or students in the same classroom/homeroom, and/or students in elementary school classes. Members of class user groups can become authorized users of class or classroom or teaching building or school information houses.

It can include but is not limited to, dormitory user groups being able to associate with related dormitory buildings or school information houses. Members of dormitory user groups include but are not limited to, students living in the same dormitory, and/or students in the same dormitory room, and/or students on the same dormitory floor. Members of dormitory user groups can become authorized users of dormitory building or school information houses.

It can include but is not limited to, student club user groups being able to associate with club or school information houses. Members of student club user groups include but are not limited to, students who are joining the same club. Members of student club user groups can become authorized users of club or school information houses.

It can include but is not limited to, teacher user groups being able to associate with class or school information houses. Members of teacher user groups include but are not limited to, teachers in the same class or teachers in the same school. Members of teacher user groups can become authorized users of class or school information houses.

It can include but is not limited to, staff user groups being able to associate with company or factory information houses. Members of staff user groups include but are not limited to, employees in the same company or factory, and/or employees in the same department. Members of staff user groups can become authorized users of company or factory information houses.

The company or factory information houses include themselves, and can further include but are not limited to, information houses according to company or factory orientation or architectural or usage characteristics, and/or square information houses, and/or road information houses, and/or store information houses, and/or canteen or restaurant information houses, and/or office district information houses, and/or conference room information houses, and/or bulletin board information houses, and/or activity venue information houses. The company or factory information houses can further include subordinate entity information houses further divided according to requirements. Activity venue information houses include but are not limited to basketball court information houses, and/or tennis court information houses, and/or fitness venue information houses, and/or lounge information houses, and/or smoking room information houses.

It can include but is not limited to, the users selecting indexes of associated entity information houses through the user groups, and/or entering the information houses to operate information, and/or send information to the entity information houses.

It can include but is not limited to, the users through the entity information houses, interacting with its associated user groups.

It can include but is not limited to, the users through family user groups, entering its associated target pet shop information house to operate information and/or sending information to the pet shop information house.

It can include but is not limited to, the users through family user groups, entering its associated target store or supermarket information house to operate information and/or sending information to the store or supermarket information house.

It can include but is not limited to, the users through family user groups, entering its associated target school information house to operate information and/or sending information to the school information house.

It can include but is not limited to, the users through family user groups, entering its associated target class information house to operate information and/or sending information to the class information house.

It can include but is not limited to, the users through family user groups, entering its associated target class information house and then entering school information houses to operate information.

It can include but is not limited to, the users through family user groups, entering its associated target hospital information house to operate information and/or sending information to the hospital information house.

It can include but is not limited to, the users through family user groups, entering its associated target hospital inpatient building or ward information house to operate information and/or sending information to the hospital inpatient building or ward information house.

It can include but is not limited to, the users through family user groups, entering its associated target hospital department information house to operate information and/or sending information to the hospital department information house.

It can include but is not limited to, the users obtaining target family household/resident information house through inner-maps of residential community information houses, and/or sending information to the house, and/or entering the house to operate information, and/or interacting with family user groups associated with the house.

It can include but is not limited to, the users through pet shop information houses, obtaining its associated target family user group and then interacting with the user group.

It can include but is not limited to, the users through store/supermarket information houses, obtaining its associated target family user group and then interacting with the user group.

It can include but is not limited to, the users through school information houses, obtaining its associated target family user group and then interacting with the user group.

It can include but is not limited to, the users through hospital information houses, obtaining its associated target family user group and then interacting with the user group.

It can include but is not limited to, the users through hospital department or inpatient building or ward information houses, obtaining its associated target family user group and then interacting with the user group.

It can include but is not limited to, two of the entity information houses forming an association relationship, and authorized users of one of the two entity information houses becoming authorized users of the other of the two entity information houses.

It can include but is not limited to, two of the entity information houses forming an association relationship, and at least one of the two entity information houses containing an index of the other of the two entity information houses.

It can include but is not limited to, two of the entity information houses forming an association relationship, the users through the other index that the one contained, entering the other to operate information, and/or sending information to the other.

It can include but is not limited to, company or factory information houses being able to associate with hotel or restaurant information houses. Staff users of company or factory information houses can have privilege of viewing live broadcast information of hotel or restaurant information houses. Information application modes of one information houses to associate with another information houses include but are not limited to, management role users or authorized users of one information house sending application or invitation information to the other, and then the two ultimately forming an association relationship after the application or invitation is allowed. The application or invitation operation includes but is not limited to, operation processes of searching by keywords or identifying information encoding of the entity information houses. The information encoding of the entity information houses includes but is not limited to information bar code or QR code.

It can include but is not limited to, one department information house of companies or factories, being able to associate with another department information house.

It can include but is not limited to, one branch information house of companies or factories, being able to associate with another branch information house. Authorized users of one branch information house can become authorized users of another.

It can include but is not limited to, two company information houses in a same office building being able to form an association relationship.

It can include but is not limited to, office building information houses and company information houses in the office building being able to form association relationships. Authorized users of company information houses can become authorized users of office information houses. The office information houses include themselves and can further include but are not limited to, information houses divided according to office building orientation or architectural or usage characteristics, and/or office building square information houses, and/or office building road information houses, and/or office building store or supermarket information houses, and/or office building canteen or restaurant information houses, and/or office building bulletin board information houses. Office building information houses can further include subordinate entity information houses further divided according to requirements.

It can include but is not limited to, two residential community information houses being able to form an association relationship. Authorized users of one residential community information can become authorized users of another.

It can include but is not limited to, two branch campus information houses of a school being able to form an association relationship. Authorized users of one branch campus information houses can become authorized users of another.

It can include but is not limited to, residential community information houses being able to associate with community organization or property company or community hospital information houses.

It can include but is not limited to, office building information houses being able to associate with community organization or property company or community hospital information houses.

It can include but is not limited to, factory or company information houses being able to associate with community organization or property company information houses.

It can include but is not limited to, residential community information houses being able to associate with jurisdiction police office or police station information houses. Authorized users of the police office or police station information houses can become Authorized users of their associated information houses.

It can include but is not limited to, office building information houses being able to associate with jurisdiction police office or police station information houses.

It can include but is not limited to, factory/company information houses being able to associate with jurisdiction police office or police station information houses.

It can include but is not limited to, school information houses being able to associate with jurisdiction police office or police station information houses.

It can include but is not limited to branch information houses of local chamber of commerce being able to form association relationships.

It can include but is not limited to branch information houses and the headquarters information house of local chamber of commerce being able to form association relationships. Authorized users of the headquarters information house can become authorized users of branch information houses, and/or authorized users of branch information houses can also become authorized users of the headquarters information house.

It can include but is not limited to, residential community information houses can comprise their own map information spaces. Each information house including residential communities can include their own map information spaces, and maps of different information houses can be different.

It can include but is not limited to, school information houses can comprise their own map information spaces. Each information house including schools can include their own map information spaces, and maps including different information houses can be different.

It can include but is not limited to, authorized users obtaining target household information houses through inner-maps of residential community information houses, and/or sending information to the target household information houses, and/or entering the target household information houses to operate information. Sending information to the information houses can be by entering or not entering them.

It can include but is not limited to, the users entering target residential community information houses to operation information through family user groups.

It can include but is not limited to, the users obtaining internal store or activity venue information houses through inner-maps of residential community information houses, and/or entering the internal store or activity venue information houses to operate information, and/or send information to the internal store or activity venue information houses.

It can include but is not limited to, authorized users or non-authorized users chatting and interacting, and/or browsing or commenting or downloading or uploading public or non-public pictures or videos in residential community information houses. The pictures or videos or internal information spaces of the information houses can or cannot be public to non-authorized users. Chat and interaction in the information houses includes but is not limited to, multiple people chatting in the chat room, and/or consulting the recent chat records of the chat room, and/or bulletin board system interaction. Authorized users roles of residential communities can be obtained by associating with family user groups or special registration management.

It can include but is not limited to, authorized users or on-site users of residential community information houses uploading pictures or videos to the residential community information houses. The on-site users of information houses mean that current location information of users is within areas of information houses.

It can include but is not limited to, the users obtaining associated target residential community information houses through police office or police station or community organization or community hospital information houses, and/or sending information to the target residential community information houses, and/or entering the target residential community information houses to operate information.

It can include but is not limited to, the users obtaining associated target residential community information houses through family user groups or police office or police station information houses and sending information to on-site users. Sending the information to on-site users of information houses can be by entering or not entering the information houses.

It can include but is not limited to, the users obtaining associated target office building information houses through police office or police station or company information houses, and/or sending information to the target office building information houses, and/or entering the target office building information houses to operate information.

It can include but is not limited to, authorized users or non-authorized users chatting and interacting, and/or browsing or commenting or downloading or uploading public or non-public pictures or videos in office building information houses. When company or factory or studio information houses associate with the office building information houses, staff users of companies or factories or studios can become authorized users of office building information houses. Authorized users roles of office building can also be obtained by special registration management.

It can include but is not limited to, the users obtaining associated target office building information houses through police office or police station or company information houses, and sending information to on-site users.

It can include but is not limited to, the users obtaining target school information houses through family user groups or alumnus user groups, and/or sending information to the target school information houses, and/or entering the target school information houses to operate information. It can include but not is limited to, the users find target school information houses by the family user groups or alumnus user groups, and enters the information houses to find operation information of school management department information houses, or to interact with user groups associated with the school management department information houses.

It can include but is not limited to, school information houses being able to associate with education management department or organization information houses. Authorized users of education management department or organization can become authorized users of school information houses.

It can include but is not limited to, the users obtaining target school information houses of through police office or police station or education management department information houses, and/or sending information to the target school information houses, and/or entering the target school information houses to operate information.

It can include but is not limited to, the users obtaining target school information houses through family user groups or alumnus user groups or entity information houses, and sending information to on-site users. The entity information houses include but are not limited to, police office or police station information houses and education management department information houses.

It can include but is not limited to, the users obtaining target school information houses through teacher user groups or class student user groups or dormitory user groups or student club user groups, and/or sending information to the target school information houses, and/or entering the target school information houses to operate information.

It can include but is not limited to, the users obtaining target school information houses through teacher user groups or class student user groups or dormitory user groups or student club user groups, and sending information to on-site users.

It can include but is not limited to, the users obtaining target class information houses through family user groups, and/or sending information to the class information houses, and/or entering the class information houses to operate information. It can include but is not limited to, users finding target class information houses through family user groups, and entering the information houses, and then continuously entering the school information houses to operate information.

It can include but is not limited to, the users obtaining target teaching department or management department information houses of school through inner-maps of school information houses, and/or sending information to the teaching department or management department information houses, and/or entering the teaching department or management department information houses to operate information.

It can include but is not limited to, authorized users or non-authorized users of schools, obtaining target school information houses through devices positioning or user groups or inner-maps of school information houses or outer-maps, and/or sending information to on-site users, and/or entering the target school information houses to chat and interact and/or browse or comment or download or upload public or non-public pictures or videos or articles. When looking up information houses on maps and looking for themselves, they need to be by outer-maps; while looking up their subordinate information houses, they can be by outer-maps or inner-maps of the information houses. Target information houses can include themselves in their names, or their subordinate information houses. Authorized users of schools include but are not limited to students, teachers, alumni and school staff. User groups of school staff being able to associate with the school information houses, so that school staff can become authorized users of schools. For authorized users and non-authorized users, different privilege for sending or operating information can be set. The authorized users roles of schools can also be obtained by special registration management.

It can include but is not limited to, authorized users or non-authorized users of schools obtaining canteen or restaurant information houses of target schools through devices positioning or user groups or inner-maps of school information houses or outer-maps, and/or sending information to the canteen or restaurant information houses, and/or entering the canteen or restaurant information houses to operate information. School canteen or restaurant information houses can be divided into subordinate information houses according to orientation, architectural characteristics or usage.

It can include but is not limited to, the users obtaining canteen or restaurant information houses of target schools through devices positioning or user groups or inner-maps of school information houses or outer-maps, and/or sending information to on-site users, and/or on-site authorized or non-authorized users uploading pictures or videos to the canteen or restaurant information houses or to internal superior information houses of the canteen or restaurant information houses. Basic information houses are school information houses in their names. For school information houses, unless otherwise specified, the following are similar. Therefore, their internal superior information houses of schools including one or more of the information houses from themselves to basic information houses, but does not include themselves. On-site authorized users or non-authorized users uploading information, the system can give different process strategies.

It can include but is not limited to, pictures or videos uploaded by users, of canteen or restaurant information houses of schools can be marked on inner-maps or internal-superior-maps or outer-maps, users through selecting target picture or video marks on the maps, and/or being able to browse or comment pictures or videos and/or enter picture or video list information spaces and/or enter the entity information houses. The “internal-superior-maps” are the abbreviation of the “maps of internal superior information houses”. The “inner-maps” are based on its front information houses, in this, are based on “canteen or restaurant information houses”. The “outer-maps” are based on the “basic information houses”. In this, basic information houses are school information houses in their names. The “internal-superior-maps” are in middle. The following are similar. In the following description, internal superior information houses, outer-maps are all based on the basic information houses.

It can include but is not limited to, authorized users or non-authorized users of schools obtaining target school bulletin board information houses through device positioning or user groups or inner-maps of school information houses or outer-maps, and/or sending information to the bulletin board information houses, and/or entering the bulletin board information houses to operate information.

It can include but is not limited to, the users obtaining target school bulletin board information houses through device positioning or user groups or inner-maps of school information houses or outer-maps, and/or sending information to on-site users, and/or on-site authorized or non-authorized users uploading pictures or videos to the bulletin board information houses or internal superior information houses of the bulletin board information houses.

It can include but is not limited to, pictures or videos uploaded by users, of school bulletin board information houses being marked on inner-maps or internal-superior-maps or outer-maps, users through selecting target picture or video marks on the maps, and/or being able to browse or comment pictures or videos and/or enter picture or video list information spaces and/or enter the entity information houses.

It can include but is not limited to, authorized users or non-authorized users of schools obtaining target school sport field information houses through device positioning or user groups or inner-maps of school information houses or outer-maps, and/or sending information to the sport field information houses, and/or entering the sport field information houses to operate information. The “sport field” includes but is not limited to stadium or gym or playground.

It can include but is not limited to, the users obtaining target school sport field information houses through device positioning or user groups or inner-maps of school information houses or outer-maps, and/or sending information to on-site users, and/or on-site authorized or non-authorized users uploading pictures or videos to the sport field information houses or internal superior information houses of the sport field information houses.

It can include but is not limited to, pictures or videos uploaded by users, of sport field information houses of schools being marked on inner-maps or internal-superior-maps or outer-maps, users through selecting target picture or video marks on the maps, and/or being able to browse or comment pictures or videos and/or enter picture or video list information spaces and/or enter the entity information houses.

It can include but is not limited to, authorized users or non-authorized users of schools obtaining target school library information houses through device positioning or user groups or inner-maps of school information houses or outer-maps, and/or sending information to the library information houses, and/or entering the library information houses to operate information.

It can include but is not limited to, the users obtaining target school library information houses through device positioning or user groups or inner-maps of school information houses or outer-maps, and/or sending information to on-site users, and/or on-site authorized users or non-authorized users uploading pictures or videos to the library information houses or to the internal superior information houses of the library information houses.

It can include but is not limited to, pictures or videos uploaded by users, of library information houses of schools being marked on inner-maps or internal-superior-maps or outer-maps, users through selecting target picture or video marks on the maps, and/or being able to browse or comment pictures or videos and/or enter picture or video list information spaces and/or enter the entity information houses.

It can include but is not limited to, the users obtaining target school dormitory information houses through device positioning or user groups or inner-maps of school information houses, and/or sending information to the dormitory information houses, and/or entering the dormitory information houses to operate information.

It can include but is not limited to, the users obtaining target school dormitory information houses through device positioning or user groups or inner-maps of school information houses or outer-maps, and/or sending information to on-site users, and/or on-site authorized users or non-authorized users uploading pictures or videos to the dormitory information houses or to internal superior information houses of the dormitory information houses.

It can include but is not limited to, pictures or videos uploaded by users, of school dormitory information houses being marked on inner-maps or internal-superior-maps or outer-maps, users through selecting target picture or video marks on maps, and/or being able to browse or comment pictures or videos and/or enter picture or video list information spaces and/or enter the entity information houses.

It can include but is not limited to, the users obtaining target school teaching building or classroom information houses through device positioning or user groups or inner-maps of school information houses or outer-maps, and/or sending information to the teaching building or classroom information houses, and/or entering the teaching building or classroom information houses to operate information.

It can include but is not limited to, the users obtaining target teaching building or classroom information houses through devices positioning or user groups or inner-maps of school information houses or outer-maps, and/or sending information to on-site users, and/or on-site authorized or non-authorized users uploading pictures or videos to the teaching building or classroom information houses or to internal superior information houses of the teaching building or classroom information houses.

It can include but is not limited to, pictures or videos uploaded by users, of teaching building or classroom information houses being marked on inner-maps or internal-superior-maps or outer-maps, users through selecting target picture or video marks on maps, and/or being able to browse or comment pictures or videos and/or enter picture or video list information spaces and/or enter the entity information houses.

It can include but is not limited to, authorized users or non-authorized users of schools obtaining target school scenic spot or square information houses through device positioning or inner-maps of school information houses or outer-maps, and/or sending information to the scenic spot or square information houses, and/or entering the scenic spot or square information houses to operate information.

It can include but is not limited to, the users obtaining target school scenic spot or square information houses through device positioning or user groups or inner-maps of school information houses or outer-maps, and/or sending information to on-site users, and/or on-site authorized or non-authorized users uploading pictures or videos to the scenic spot or square information houses or to internal superior information houses of the scenic spot or square information houses.

It can include but is not limited to, pictures or videos uploaded by users, of school scenic spot or square information houses being marked on inner-maps or internal-superior-maps or outer-maps, users through selecting target picture or video marks on maps, and/or being able to browse or comment pictures or videos and/or enter picture or video list information spaces and/or enter the entity information houses.

It can include but is not limited to, authorized users or non-authorized users of schools obtaining target school road or road section information houses through device positioning or user groups or inner-maps of school information houses or outer-maps, and/or sending information to the road or road section information houses, and/or entering the road or road section information houses to operate information.

It can include but is not limited to, the users obtaining target school road or road section information houses through devices positioning or user groups or inner-maps of school information houses or outer-maps, and/or sending information to on-site users, and/or on-site authorized users or non-authorized users uploading pictures or videos to the road or road section information houses or to internal superior information houses of the road or road section information houses.

It can include but is not limited to, pictures or videos uploaded by users, of school road or road section information houses being marked on inner-maps or internal-superior-maps or outer-maps, users through selecting target picture or video marks on the maps, and/or being able to browse or comment pictures or videos and/or enter picture or video list information spaces and/or enter the entity information houses.

It can include but is not limited to, authorized users or non-authorized users of schools obtaining target school area information houses through device positioning or user groups or inner-maps of school information houses or outer-maps, and/or sending information to the area information houses, and/or entering the area information houses to operate information.

It can include but is not limited to, users obtaining target school area information houses through devices positioning or user groups or inner-maps of school information houses or outer-maps, and/or sending information to on-site users, and/or on-site authorized users or non-authorized users uploading pictures or videos to the area information houses or to internal superior information houses of the area information houses.

It can include but is not limited to, pictures or videos uploaded by users, of school area information houses being marked on inner-maps or internal-superior-maps or outer-maps, users through selecting target picture or video marks on the maps, and/or being able to browse or comment pictures or videos and/or enter picture or video list information spaces and/or enter the entity information houses.

It can include but is not limited to, authorized users or non-authorized users of schools obtaining target school store information houses through devices positioning or user groups or inner-maps of school information houses or outer-maps, and/or sending information to the store information houses, and/or entering the store information houses to operate information.

It can include but is not limited to, the users obtaining target school store information houses through devices positioning or user groups or inner-maps of school information houses or outer-maps, and/or sending information to on-site users, and/or on-site authorized users or non-authorized users uploading pictures or videos to the store information houses or to internal superior information houses of the store information houses.

It can include but is not limited to, pictures or videos uploaded by users, of school store information houses being marked on inner-maps or internal-superior-maps or outer-maps, users through selecting target picture or video marks on the maps, and/or being able to browse or comment pictures or videos and/or enter picture or video list information spaces and/or enter the entity information houses.

It can include but is not limited to, authorized users or non-authorized users of schools obtaining target school hospital information houses through device positioning or user groups or inner-maps of school information houses or outer-maps, and/or sending information to the hospital information houses, and/or entering the hospital information houses to operate information.

Above information houses associated with schools including but not limited to schools on their names, and/or school areas, and/or canteens or restaurants, and/or bulletin boards, and/or roads or road sections, and/or libraries, and/or sports venues, and/or scenic spots or squares, and/or teaching buildings or classrooms, and/or school hospital, can be divided into subordinate information houses according to actual requirements. The subordinate information houses include one or more levels of subordinates.

It can include but is not limited to, authorized users or non-authorized users obtaining target company or factory information houses through user groups or device positioning or inner-maps of company or factory information houses or outer-maps, and/or sending information to on-site users, and/or entering the company or factory information houses to chat and interact, and/or browse or comment or download or upload public or non-public pictures or videos or articles.

It can include but is not limited to, authorized users or non-authorized users of companies or factories obtaining target company or factory activity venue information houses through device positioning or inner-maps of company or factory information houses or outer-maps, and/or sending information to on-site users, and/or entering the activity venue information houses to chat and interact, and/or browse or comment or download or upload public or non-public pictures or videos or articles. Activity venue include but are not limited to fitness venues, and/or sports fields, and/or lawns, and/or squares, and/or roads, and/or lounge rooms, and/or tea room and/or smoking rooms.

It can include but is not limited to, authorized users or non-authorized users of companies or factories obtaining target company or factory activity venue information houses through the user groups or device positioning or inner-maps of company or factory information houses or outer-maps, and/or sending information to on-site users, and/or on-site authorized users or non-authorized users uploading pictures or videos to the activity venue information houses or to internal superior information houses of the activity venue information houses. Basic information houses are company or factory information houses in their names. For company or factory information houses, unless otherwise specified, the followings are similar.

It can include but is not limited to, pictures or videos uploaded by users, of company or factory activity venue information houses being marked on inner-maps or internal-superior-maps or outer-maps, users through selecting target picture or video marks on the maps, and/or being able to browse or comment pictures or videos and/or enter picture or video list information spaces and/or enter the entity information houses.

It can include but is not limited to, authorized users or non-authorized users of companies or factories obtaining target canteen or restaurant information houses through user groups or device positioning or inner-maps of company or factory information houses or outer-maps, and/or sending information to on-site users, and/or entering the canteen or restaurant information houses to chat and interact, and/or browse or comment or download or upload public or non-public pictures or videos or articles.

It can include but is not limited to, the users obtaining target canteen or restaurant information houses of companies or factories through device positioning or user groups or inner-maps of the company or factory information houses or outer-maps, and/or sending information to on-site users, and/or on-site authorized users or non-authorized users uploading pictures or videos to the canteen or restaurant information houses or to internal superior information houses of the canteen or restaurant information houses.

It can include but is not limited to, pictures or videos uploaded by users, of canteen or restaurant information houses of companies or factories being marked on inner-maps or internal-superior-maps or outer-maps, users through selecting target picture or video marks on the maps, and/or being able to browse or comment pictures or videos and/or enter picture or video list information spaces and/or enter the entity information houses.

It can include but is not limited to, authorized users or non-authorized users of companies or factories obtaining target office area or office building or office information houses through device positioning or inner-maps of company or factory information houses or outer-maps, and/or sending information to on-site users, and/or entering the office area or office building or office information houses to chat and interact, and/or browse or comment or download or upload public or non-public pictures or videos or articles.

It can include but is not limited to, the users obtaining target office area or office building or office information houses of companies or factories through device positioning or inner-maps of company or factory information houses or outer-maps, and/or sending information to on-site users, and/or on-site authorized users or non-authorized users uploading pictures or videos to the office area or office building or office information houses or to internal superior information houses of the office area or office building or office information houses.

It can include but is not limited to, pictures or videos uploaded by users, of office area or office building or office information houses of companies or factories being marked on inner-maps or internal-superior-maps or outer-maps, users through selecting target picture or video marks on the maps, and/or being able to browse or comment pictures or videos and/or enter picture or video list information spaces and/or enter the entity information houses.

It can include but is not limited to, the users obtaining target street information houses through device positioning or inner-maps of street information houses or outer-maps, and/or sending information to on-site users, and/or entering the street information houses to chat and interact, and/or browse or comment or download or upload pictures or videos or articles.

It can include but is not limited to, users obtaining target street information houses through device positioning or inner-maps of street information houses or outer-maps, and/or sending information to on-site users, and/or on-site or off-site users uploading pictures or videos or articles to the street information houses or to internal superior information houses of the street information houses. Basic information houses are street information houses in their names. For street information houses, unless otherwise specified, the followings are similar. For on-site or off-site users uploading pictures or videos, the system can adopt different process strategies, including prohibiting off-site users from uploading pictures or videos.

It can include but is not limited to, pictures or videos uploaded by users, of street information houses being marked on inner-maps or internal-superior-maps or outer-maps, users through selecting target picture or video marks on the maps, and/or being able to browse or comment pictures or videos and/or enter picture or video list information spaces and/or enter the entity information houses. Street information houses can be divided into subordinate information houses according to actual requirements.

It can include but is not limited to, the users obtaining target city area or block information houses through devices positioning or inner-maps of city or area or block information houses or outer-maps, and/or sending information to on-site users, and/or entering the area or block information houses to chat and interact, and/or browse or comment or download or upload pictures or videos or articles. City area or block information houses can be divided into subordinate information houses according to actual requirements.

It can include but is not limited to, the users obtaining target city area or block information houses through devices positioning or inner-maps of city or area or block information houses or outer-maps, and/or sending information to on-site users, and/or on-site users or off-site users uploading pictures or videos or articles to the area or block information houses or to internal superior information houses of the area or block information houses. Basic information houses refer to city area or block information houses on their names. For city area or block information houses, unless otherwise specified, the followings are similar.

It can include but is not limited to, pictures or videos uploaded by users, of city area or block information houses being marked on inner-maps or internal-superior-maps or outer-maps, users through selecting target picture or video marks on the maps, and/or being able to browse or comment pictures or videos and/or enter picture or video list information spaces and/or enter the entity information houses.

It can include but is not limited to, the users obtaining target road or road section information houses through device positioning or inner-maps of road or road section information houses or outer-maps, and/or sending information to on-site users, and/or entering the road or road section information houses to chat and interact, and/or browse or comment or download or upload pictures or videos or articles. Roads or road sections can include physical environment on both sides. Roads or road section information houses can be divided into subordinate information houses according to actual requirements.

It can include but is not limited to, the users obtaining target road or road section information houses through devices positioning or inner-maps of road or road section information houses or outer-maps, and/or sending information to on-site users, and/or on-site users or off-site users uploading pictures or videos or articles to the road or road section information houses or to internal superior information houses of the road or road section information houses. Basic information houses refer to road or road section information houses on their names. For road or road section information houses, unless otherwise specified, the followings are similar.

It can include but is not limited to, pictures or videos uploaded by users, of road or road section information houses being marked on inner-maps or internal-superior-maps or outer-maps, users through selecting target picture or video marks on the maps, and/or being able to browse or comment pictures or videos and/or enter picture or video list information spaces and/or enter the entity information houses.

It can include but is not limited to, the users obtaining target television station or station or airport or film base or amusement park or square or park or scenic area or scenic spot information houses through device positioning or inner-maps of television station or station or airport or film base or amusement park or square or park or scenic area or scenic spot information houses or outer-maps, and/or sending information to on-site users, and/or entering the television station or station or airport or film base or amusement park or square or park or scenic area or scenic spot information houses to chat and interact, and/or browse or comment or download or upload picture or videos or articles. Television station or station or airport or film base or amusement park or square or park or scenic area or scenic spot information houses can be divided into subordinate information houses according to actual requirements, including but not limited to areas and/or stores and/or restaurants and/or squares and/or streets and/or architectures and/or facilities and/or landscapes information houses.

It can include but is not limited to, the users obtaining target information houses through device positioning or inner-maps of television station or station or airport or film base or amusement park or square or park or scenic area or scenic spot information houses or outer-maps, and/or sending information to on-site users, and/or the on-site users or off-site users uploading pictures or videos or articles to the target information houses or to internal superior information houses of the target information houses. Basic information houses refer to television station or station or airport or film base or amusement park or square or park or scenic area or scenic spot information houses in their names.

It can include but is not limited to, pictures or videos uploaded by users, of television station or station or airport or film base or amusement park or square or park or scenic area or scenic spot information houses being marked on inner-maps or internal-superior-maps or outer-maps, users through selecting target picture or video marks on maps, and/or being able to browse or comment picture or videos and/or enter picture or video list information spaces and/or enter the entity information houses.

It can include but is not limited to, the users obtaining target subway line or line section information houses through device positioning or inner-maps of subway line or line section information houses or outer-maps, and/or sending information to on-site users, and/or entering the subway line or line section information houses to chat and interact, and/or browse or comment or download or upload pictures or videos or articles. Subway line or line section information houses can be divided into subordinate information houses according to actual requirements.

It can include but is not limited to, the users obtaining target subway line or line section information houses through device positioning or inner-maps of subway line or line section information houses or outer-maps, and/or sending information to on-site users, and/or the on-site users or off-site users uploading pictures or videos or articles to the subway line or line section information houses or to internal superior information houses of the subway line or line section information houses. Basic information houses refer to subway line or line section information houses in their names.

It can include but is not limited to, pictures or videos uploaded by users, of subway line or line section information houses being marked on inner-maps or internal-superior-maps or outer-maps, users through selecting target picture or video marks on maps, and/or being able to browse or comment pictures or videos and/or enter picture or video list information spaces and/or enter the entity information houses.

It can include but is not limited to, the users obtaining target hospital information houses through device positioning or user groups or inner-maps of hospital information houses or outer-maps, and sending information to on-site users, and/or entering the hospital information houses to chat and interact, and/or browse or comment or download or upload pictures or videos or articles. Hospital information houses can be divided into subordinate according to actual requirements, including but not limited to hospital area and/or halls and/or squares and/or departments and/or inpatient departments and/or ward information houses.

It can include but is not limited to, the users obtaining target hospital information houses through device positioning or user groups or inner-maps of the hospital information houses or outer-maps, and/or sending information to on-site users, and/or the on-site users or off-site users uploading pictures or videos or articles to the hospital information houses or to internal superior information houses of the hospital information houses. Basic information houses refer to hospital information houses in their names.

It can include but is not limited to, pictures or videos uploaded by users, of hospital information houses being marked on inner-maps or internal-superior-maps or outer-maps, users through selecting target picture or video marks on the maps, and/or being able to browse or comment pictures or videos and/or enter picture or video list information spaces and/or enter the entity information houses.

It can include but is not limited to, the users obtaining target mountain or river information houses through device positioning or inner-maps of mountain or river information houses or outer-maps, and/or sending information to on-site users, and/or entering the mountain or river information houses to chat and interact, and/or browse or comment or download or upload pictures or videos or articles. Mountain or river information houses can be subordinate information houses according to requirements.

It can include but is not limited to, the users obtaining target mountain or river information houses through device positioning or inner-maps of mountain or river information houses or outer-maps, and/or sending information to on-site users, and/or the on-site users or off-site users uploading pictures or videos or articles to the mountain or river information houses or to internal superior information houses of the mountain or river information houses.

It can include but is not limited to, pictures or videos uploaded by users, of mountain or river information houses being marked on inner-maps or internal-superior-maps or outer-maps, users through selecting target picture or video marks on the maps, and/or being able to browse or comment pictures or videos and/or enter picture or video list information spaces and/or enter the entity information houses.

It can include but is not limited to, the users obtaining target theater or cinema or bar or dance hall information houses through device positioning or inner-maps of theater or cinema or bar or dance hall information houses or outer-maps, and/or sending information to on-site users, and/or entering the mountain or river information houses to chat and interact, and/or browse or comment or download or upload pictures or videos or articles. Theater or cinema or bar or dance hall information houses can be divided into subordinate information houses according to actual requirements.

It can include but is not limited to, the users obtaining target theater or cinema or bar or dance hall information houses through devices positioning or inner-maps of theater or bar or dance hall information houses or outer-maps, and/or sending information to on-site users, and/or the on-site users or off-site users uploading pictures or videos or article to the theater or cinema or bar or dance hall information houses or to their internal superior information houses. Basic information houses refer to theater or bar or dance hall information houses in their names.

It can include but is not limited to, pictures or videos uploaded by users, of theater or cinema or bar or dance hall information houses being marked on inner-maps or internal-superior-maps or outer-maps, users through selecting target picture or video marks on maps, and/or being able to browse or comment pictures or videos and/or enter picture or video list information spaces and/or enter the entity information houses.

It can include but is not limited to, the users obtaining target rally or temple fair or marathon or sports meeting or bicycle race or ball game or concert or opening ceremony or graduation ceremony or wedding information houses by device positioning or inner-maps of rally or temple fair or marathon or sports meeting or bicycle race or ball game or concert or opening ceremony or graduation ceremony or wedding information houses or outer-maps, and/or sending information to on-site users, and/or entering the rally or temple fair or marathon or sports meeting or bicycle race or ball game or concert or opening ceremony or graduation ceremony or wedding information houses to chat and interact, and/or browse or comment or download or upload pictures or videos or articles. Rally or temple fair or marathon or sports meeting or bicycle race or ball game or concert or opening ceremony or graduation ceremony or wedding information houses can be divided into subordinate information houses according to actual requirements.

It can include but is not limited to, the users obtaining target rally or temple fair or marathon or sports meeting or bicycle race or ball game or concert or opening ceremony or graduation ceremony or wedding information houses through device positioning or inner-maps of rally or temple fair or marathon or sports meeting and/or bicycle race or ball game and/or concert or opening ceremony or graduation ceremony or wedding information houses or outer-maps, and/or sending information to on-site users, and/or the on-site users or off-site users uploading pictures or videos or articles to the rally or temple fair or marathon or sports meeting or bicycle race or ball game or concert or opening ceremony or graduation ceremony or wedding information houses or to internal superior information houses of the rally or temple fair or marathon or sports meeting or bicycle race or ball game or concert or opening ceremony or graduation ceremony or wedding information houses. Basic information houses refer to rally or temple fair or marathon or sports meeting or bicycle race or ball game or concert or opening ceremony or graduation ceremony or wedding information houses in their names.

It can include but is not limited to, pictures or videos uploaded by users, of rally or temple fair or marathon or sports meeting or bicycle race or ball game or concert or opening ceremony or graduation ceremony or wedding information houses being marked on inner-maps or internal-superior-maps or outer-maps, users through selecting target picture or video marks on the maps, and/or being able to browse or comment pictures or videos and/or enter picture or video list information spaces and/or enter the entity information houses.

It can include but is not limited to, the users obtaining target earthquake or fire disaster or wind disaster or flood or accident or hot event information houses through device positioning or inner-maps of earthquake or fire disaster or wind disaster or flood or accident or hot event information houses or outer-maps, and/or sending information to on-site users, and/or entering the earthquake or fire disaster or wind disaster or flood or accident or hot event information houses to chat and interact, and/or browse or comment or download or upload pictures or videos or articles. Earthquake or fire disaster or wind disaster or flood or accident or hot event information houses can be divided into subordinate information houses according to actual requirements.

It can include but is not limited to, the users obtaining target earthquake or fire disaster or wind disaster or flood or accident or hot event information houses through device positioning or inner-maps of earthquake or fire disaster or wind disaster or flood or accident or hot event information houses or outer-maps, and/or sending information to on-site users, and/or the on-site users or off-site users uploading pictures or videos or articles to the earthquake or fire disaster or wind disaster or flood or accident or hot event information houses or to internal superior information houses of the earthquake or fire disaster or wind disaster or flood or accident or hot event information houses. Basic information houses refer to earthquake or fire disaster or wind disaster or flood or accident or hot event information houses in their names.

It can include but is not limited to, pictures or videos uploaded by users, of earthquake or fire disaster or wind disaster or flood or accident or hot event information houses being marked on inner-maps or internal-superior-maps or outer-maps, users through selecting target pictures or video marks on the maps, and/or being able to browse or comment pictures or videos and/or enter picture or video list information spaces and/or enter the entity information houses.

It can include but is not limited to, the users obtaining associated target community organization or police office or police station or community hospital information houses through residential community information houses, and/or sending information to the community organization or police office or police station or community hospital information houses, and/or entering the community organization or police office or police station or community hospital information houses to operate information.

It can include but is not limited to, the users obtaining associated target community organization or police office or police station or community hospital information houses through company or factory or office building information houses, and/or sending information to the community organization or police office or police station or community hospital information houses, and/or entering the community organization or police office or police station or community hospital information houses to operate information.

It can include but is not limited to, street or block information houses being able to associate with community organization or police office or police station information houses.

It can include but is not limited to, ball game fan user groups or sport fan user groups being able to associate with ball game fan association or stadium or gymnasium or sport venue information houses.

It can include but is not limited to, two relative family user groups being able to form an association relationship. The two user groups forming an association relationship include but are not limited to, one user group can include indexes of another user group, and/or users of one user group can interact with another user group. Interactions with user groups include but are not limited to sending messages, and/or entering groups, and/or participating in chats.

It can include but is not limited to, alumnus user groups being able to form association relationships.

It can include but is not limited to, family user groups and medical staff user groups being able to be in a same user group.

It can include but is not limited to, family user groups and teacher user groups being able to be in a same user group.

It can include but is not limited to, class student user groups and teacher user groups being able to be in a same user group.

It can include but is not limited to, department user groups of companies or factories being able to form association relationships.

It can include but is not limited to, dormitory user groups of being able to form association relationships.

It can include but is not limited to, family user groups and management user groups of resident communities being able to be in a same group.

The invention also involves an information connection apparatus based on entity information houses, comprising a server end and a user end, the server end being installed on the back-end server, the user end being installed on notebooks, desktop computers, and handheld equipment, when an information connection device constituted by the server end and the user end operates, the information connection method as described above. The handheld equipment in this description include but are not limited to cell phone, tablet personal computer.

### BRIEF DESCRIPTION OF THE DRAWINGS

For more clear explanation of technical solutions in the examples of the present application or in related arts, the drawings required to be used in examples or related arts will be introduced as below. Obviously, the drawings in the below description are only some examples of the present application. For one of ordinary skilled in the art, other drawings can be obtained based on the structure shown in these drawings without creative work.

FIG. 1 is a schematic diagram of an example of an information connection device based on entity information houses according to the present application;

FIG. 2 is a schematic diagram of entering information spaces according to the present application.

### DETAILED DESCRIPTION OF THE EMBODIMENTS

An information connection method and device based on entity information houses. The overall structure includes a user end and a serving end. The user end is installed or presented on a user equipment, and the serving end is installed on a back-end server. The user end includes map tab pages or map windows, and/or group collection windows, and/or index collection windows of entity information houses.

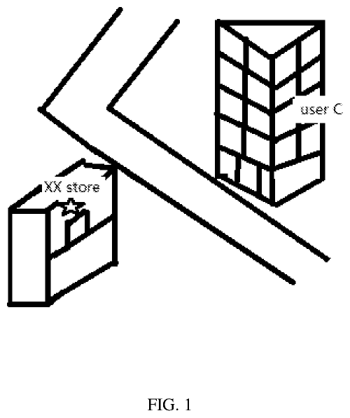

FIG. 1 is a schematic diagram of an information connection device based on entity information houses according to the present application.

Referring to FIG. 1, user C obtains maps of a residential community information house where the he locates by device positioning or family user groups, and obtains store information spaces surrounding him (for example: XX store), and then enters the store information spaces by the maps of the residential community information house.

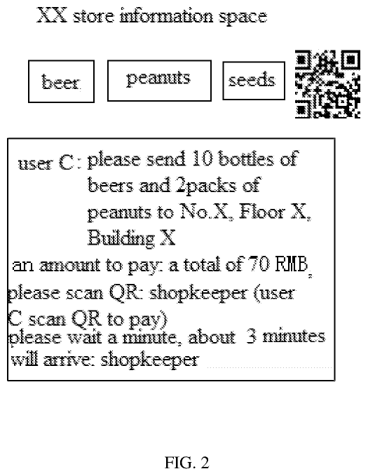

FIG. 2 is a schematic diagram of entering information spaces according to the present application.

Referring to FIG. 2, the user C enters a certain (XX) store information space. The store information space is equipped with various commodities. The user C can chat with the shopkeeper according to his own requirements, and provide requirements for commodity selection, such as selecting beer, peanuts, seeds and so on, such as, please send 10 bottles of beers and 2 packs of peanuts to No. X, Floor X, Building X. The shopkeeper tells the user C an amount to pay: a total of 70 RMB, and then prompts the user C to scan a code. A QR code will be displayed on the store information space, and the user C can scan the QR code to pay.

### Example One

A male user B in a university A likes a girl C, and knows that the girl C often goes to two classrooms E1 and E2 of teaching building D to study at night, and hopes to determine a location of the girl C by the device.

Step One:

The user B enters a map window, and obtains an information house of the university A by map roaming or positioning, and then enters the information house.

Step Two:

The user B finds the teaching building D by a map of a map information space of the information house of the university A.

Step Three:

The User B finds classroom E1 by a map of a map information space of an information house of the teaching building D.

The User B checks on-site events or a status information space or an interactive information space of an information house of the classroom E1, and finding that there are no pictures or videos about the last fifteen minutes of the classroom E1.

Step Four:

Thus, the user B sends an invitation or requests to upload the latest pictures or videos of the classroom E1 in the information house of the classroom E, and his reward can also be provided.

Similarly, the user B can send an invitation or request information in an information house of the classroom E2.

Step Five:

The invitation or request information sent by the user B will be transmitted to the serving end, and the serving end will form a piece of reminder information by calculation and send it to on-site users in the classroom E1.

Step Six:

After on-site users of the classroom E1 receive the information, users who are willing to respond will take pictures or record videos, and enter the information house of the classroom E1 following step 1, or step 2, or step 3 (other paths: first, the on-site users may already be in the information house of the classroom E1, so there are no needs to go through the above steps. Second, the on-site users can enter quickly by map positioning, thereby omitting step 1 or step 2), to upload or issue pictures or videos in the on-site event or status information space or an interactive information space.

There may also be on-site users of the classroom E1 who enjoy playing, having entered the information house of the classroom E1 after step 1, or step 2, or step 3 or after some of these steps, and uploaded or issued pictures or videos just before the user B sends out an invitation or request information.

Step Seven:

After user B issues an invitation or request information, users who have uploaded pictures or videos can be rewarded according to calculation rules of the system.

### Example Two

A family A has four parents and two children. The children are in class C in kindergarten B and class E in primary school D, respectively. The four parents of the family A have just become users of this product and formed a group F. The family A lives in a community G. The community G is under the jurisdiction of neighborhood committee H.

Step One:

The family A finds a QR code of the information house of kindergarten B and primary school C.

Step Two:

A member of the family A enters the group F, and scans the QR code of the information house of the kindergarten B, and initiates an association request to an information house of the kindergarten B.

Step Three:

After being authenticated, the group F is associated with an information house of the glade or an information house of the class C by a management user of the information house of the kindergarten B.

Thus, members of the group F all obtain parent member user identities of the information house of the kindergarten B.

At the same time, indexes of the information house of the kindergarten B are also registered in index spaces of the group F.

Step Four:

Any member of the group F can quickly enter the information house of the kindergarten B by indexes of the information house of the kindergarten B in the group F.

Step Five:

After any member of the group F enters the information house of the kindergarten B, due to his member user identity of the kindergarten, he can communicate with teachers, or parents of other families in interactive information spaces of the information house of the kindergarten B, or browse or download his children's pictures or videos in on-site event or status information spaces.

Step Six:

A member of the family A enters the group F, scans a QR code of an information house of the primary school D, and initiates an association request to the information house of the primary school D.

### Example Three

A family A forms a group F. The family A lives in a community G, and the community G is under the jurisdiction of the neighborhood committee H.

An association between the community G and the neighborhood committee H has been established.

Very accidentally, the family A is looking for the neighborhood committee H.

Step One:

A member of the family A enters the group F, scans a QR code of a information house of the community G, and initiates an association request to the information house of the community G.

Step Two:

After being authenticated, the group F can be associated with a household information house of the family A (an information house of the family A) by a community administrator.

Step Three:

Members of the family A enter the group F, find indexes of the information house of the community G, and enter the information house of the community G.

Step Four:

After members of the family A enter the information house of the community G, they find an index of a neighborhood committee H in the index space, and can enter the neighborhood committee H by the index.

Step Five:

After members of the family A enter the neighborhood committee H, they can communicate with each other in an interactive information space or a suggestion information space of the information house of the neighborhood committee H.

### Example Four

A family A forms a group F. The family A lives in a community G, and the community G is under the jurisdiction of a neighborhood committee H.

An association between the group F and the community G and an association between the community G and the neighborhood committee H have been established.

Very accidentally, the neighborhood committee H is looking for the family A.

Step One:

An administrator of the neighborhood committee H finds an information house of the community G by the index and enters the information house.

Step Two:

The administrator of the neighborhood committee H finds the household information house of the family A by map information in a map information space of the information house of the community G.

He enters the household information house of the family A.

Step Three:

The administrator of the neighborhood committee H either leaves messages in an interactive information space of the household information house of the family A, or finds an index of the group F and sends messages to the group F.

The above descriptions are only preferred embodiments of the present invention and are not intended to limit the present invention. Any modification, equivalent replacement and improvement made within the spirit and principle of the present invention shall be included in the protection scope of the present invention.

What is claimed is:

1. An information connection method based on entity information houses, including one or more types of information components and information application modes based on interiors of the information components and between the information components;
wherein, the information components include entity information houses and/or map information spaces, and/or index collection information spaces of the entity information houses, and/or article information spaces, and/or user groups;
wherein, the map information spaces or the article information spaces is comprised in the entity information houses or not;
wherein, the information application modes include entry modes of the entity information houses, and/or two of the user groups forming an association relationship, and/or the user groups and the entity information houses forming association relationships, and/or two of the entity information houses forming an association relationship, and/or building the user groups which at least comprise one of users and user group;
wherein, the entity information houses include one or more of interactive information spaces and/or situation information spaces and/or announcement information spaces and/or commodity or service display information spaces and/or map information spaces and/or article information spaces and/or live broadcast information spaces;
wherein, the entry modes of the entity information houses include an entry mode of the users selecting marks on a map to enter, and/or an entry mode of the users selecting target entity information houses from the index collection information spaces of the entity information houses to enter, and/or an entry mode of the users to enter through index of the entity information houses associated with the user groups, and/or an entry mode of the users to enter through marks related to the entity information houses and added to articles, and/or an entry mode of the users to enter via device positioning.

2. The information connection method based on entity information houses according to claim 1, further comprising marking the entity information houses on maps, and the users entering target information houses by selecting marks of the entity information houses on the maps.

3. The information connection method based on entity information houses according to claim 1, further comprising uploading pictures and videos by management role users or authorized users of store or restaurant or company or factory information houses, and/or marking the pictures and videos on outer-maps of the information houses, and/or browsing or commenting the pictures or videos and/or entering the information houses by the users selecting target marks marked on the outer-maps.

4. The information connection method based on entity information houses according to claim 1, further comprising pictures or videos can be uploaded by on-site users of the entity information houses, and/or the pictures or videos can be marked on the inner-maps or outer-maps of the information houses.

5. The information connection method based on entity information houses according to claim 1, further comprising locations, marked on the maps, of pictures or videos uploaded by the users being corresponded to locations of users who upload or locations information contained in the pictures or videos.

6. The information connection method based on entity information houses according to claim 1, further comprising user groups forming association relationships with the entity information houses, and members of the user groups being able to become authorized users of the entity information houses.

7. The information connection method based on entity information houses according to claim 1, further comprising user groups forming association relationships with the entity information houses, and an index of one of the user groups and the entity information houses at least being existed in an information set of the other of the user groups and the entity information houses.

8. The information connection method based on entity information houses according to claim 1, further comprising user groups forming association relationships with entity information houses, and members of the user groups being able to enter the entity information houses by indexes of the entity information houses in the user groups.

9. The information connection method based on entity information houses according to claim 1, further comprising family user groups being able to associate with one or more types of the entity information houses.

10. The information connection method based on entity information houses according to claim 1, further comprising family user groups being able to associate with hotel or restaurant information houses.

11. The information connection method based on entity information houses according to claim 1, further comprising family user groups being able to associate with church information houses.

12. The information connection method based on entity information houses according to claim 1, further comprising family user groups being able to associate with scenic area or scenic spot information houses.

13. The information connection method based on entity information houses according to claim 1, further comprising family user groups being able to associate with pet shop information houses.

14. The information connection method based on entity information houses according to claim 1, further comprising family user groups being able to associate with hospital information houses.

15. The information connection method based on entity information houses according to claim 1, further comprising family user groups being able to associate with hospital inpatient building or ward information houses.

16. The information connection method based on entity information houses according to claim 1, further comprising family user groups being able to associate with hospital department information houses.

17. The information connection method based on entity information houses according to claim 1, further comprising doctor or nurse user groups being able to associate with hospital information houses.

18. The information connection method based on entity information houses according to claim 1, further comprising doctor or nurse user groups being able to associate with hospital department information houses.

19. The information connection method based on entity information houses according to claim 1, further comprising doctor or nurse user groups being able to associate with hospital inpatient building or ward information houses.

20. The information connection method based on entity information houses according to claim 1, further comprising family user groups being able to associate with store or supermarket information houses.

21. The information connection method based on entity information houses according to claim 1, further comprising family user groups being able to associate with school information houses.

22. The information connection method based on entity information houses according to claim 1, further comprising family user groups being able to associate with class information houses.

23. The information connection method based on entity information houses according to claim 1, further comprising family user groups being able to associate with residential community information houses.

24. The information connection method based on entity information houses according to claim 1, further comprising family user groups being able to associate with family household information houses.

25. The information connection method based on entity information houses according to claim 1, further comprising alumnus user groups being able to associate with school information houses.

26. The information connection method based on entity information houses according to claim 1, further comprising class user groups being able to associate with class or classroom or teaching building or school information houses.

27. The information connection method based on entity information houses according to claim 1, further comprising dormitory user groups being able to associate with related dormitory building or school information houses.

28. The information connection method based on entity information houses according to claim 1, further comprising student club user groups being able to associate with club or school information houses.

29. The information connection method based on entity information houses according to claim 1, further comprising teacher user groups being able to associate with class or school information houses.

30. The information connection method based on entity information houses according to claim 1, further comprising staff user groups being able to associate with company or factory information houses.

31. The information connection method based on entity information houses according to claim 1, further comprising the users selecting indexes of associated entity information houses through the user groups, and/or entering the information houses to operate information, and/or send information to the entity information houses.

32. The information connection method based on entity information houses according to claim 1, further comprising the users through the entity information houses, interacting with its associated user groups.

33. The information connection method based on entity information houses according to claim 1, further comprising the users through family user groups, entering its associated target pet shop information house to operate information and/or sending information to the pet shop information house.

34. The information connection method based on entity information houses according to claim 1, further comprising the users through family user groups, entering its associated target store or supermarket information house to operate information and/or sending information to the store or supermarket information house.

35. The information connection method based on entity information houses according to claim 1, further comprising the users through family user groups, entering its associated target school information house to operate information and/or sending information to the school information house.

36. The information connection method based on entity information houses according to claim 1, further comprising the users through family user groups, entering its associated class information house to operate information and/or sending information to the class information house.

37. The information connection method based on entity information houses according to claim 1, further comprising the users through family user groups, entering its associated target class information house and then entering school information houses to operate information.

38. The information connection method based on entity information houses according to claim 1, further comprising the users through family user groups, entering its associated target hospital information house to operate information and/or sending information to the hospital information house.

39. The information connection method based on entity information houses according to claim 1, further comprising the users through family user groups, entering its associated target hospital inpatient building or ward information house to operate information and/or sending information to the hospital inpatient building or ward information house.

40. The information connection method based on entity information houses according to claim 1, further comprising the users through family user groups, entering its associated target hospital department information house to operate information and/or sending information to the hospital department information house.

41. The information connection method based on entity information houses according to claim 1, further comprising the users obtaining target family household/resident information house through inner-maps of residential community information houses, and/or sending information to the house, and/or entering the house to operate information, and/or interacting with family user groups associated with the house.

42. The information connection method based on entity information houses according to claim 1, further comprising the users through pet shop information houses, obtaining its associated target family user group and then interacting with the user group.

43. The information connection method based on entity information houses according to claim 1, further comprising the users through store/supermarket information houses, obtaining its associated target family user group and then interacting with the user group.

44. The information connection method based on entity information houses according to claim 1, further comprising the users through school information houses, obtaining its associated target family user group and then interacting with the user group.

45. The information connection method based on entity information houses according to claim 1, further comprising the users through hospital information houses, obtaining its associated target family user group and then interacting with the user group.

46. The information connection method based on entity information houses according to claim 1, further comprising the users through hospital department or inpatient building or ward information houses, obtaining its associated target family user group and then interacting with the user group.

47. The information connection method based on entity information houses according to claim 1, further comprising two of the entity information houses forming an association relationship, and authorized users of one of the two entity information houses becoming authorized users of the other of the two entity information houses.

48. The information connection method based on entity information houses according to claim 1, further comprising two of the entity information houses forming an association relationship, and at least one of the two entity information houses containing an index of the other of the two entity information houses.

49. The information connection method based on entity information houses according to claim 1, further comprising two of the entity information houses forming an association relationship, the users through the other index that the one contained, entering the other to operate information, and/or sending information to the other.

50. The information connection method based on entity information houses according to claim 1, further comprising company or factory information houses being able to associate with hotel or restaurant information houses.

51. The information connection method based on entity information houses according to claim 1, further comprising one department information house of companies or factories, being able to associate with another department information house.

52. The information connection method based on entity information houses according to claim 1, further comprising one branch information house of companies or factories, being able to associate with another branch information house.

53. The information connection method based on entity information houses according to claim 1, further comprising two company information houses in a same office building being able to form an association relationship.

54. The information connection method based on entity information houses according to claim 1, further comprising office building information houses and company information houses in the office building being able to form association relationships.

55. The information connection method based on entity information houses according to claim 1, further comprising two residential community information houses being able to form an association relationship.

56. The information connection method based on entity information houses according to claim 1, further comprising two branch campus information houses of a school being able to form an association relationship.

57. The information connection method based on entity information houses according to claim 1, further comprising residential community information houses being able to associate with community organization or property company or community hospital information houses.

58. The information connection method based on entity information houses according to claim 1, further comprising office building information houses being able to associate with community organization or property company or community hospital information houses.

59. The information connection method based on entity information houses according to claim 1, further comprising factory or company information houses being able to associate with community organization or property company information houses.

60. The information connection method based on entity information houses according to claim 1, further comprising residential community information houses being able to associate with jurisdiction police office or police station information houses.

61. The information connection method based on entity information houses according to claim 1, further comprising office building information houses being able to associate with jurisdiction police office or police station information houses.

62. The information connection method based on entity information houses according to claim 1, further comprising factory/company information houses being able to associate with jurisdiction police office or police station information houses.

63. The information connection method based on entity information houses according to claim 1, further comprising school information houses being able to associate with jurisdiction police office or police station information houses.

64. The information connection method based on entity information houses according to claim 1, further comprising branch information houses of local chamber of commerce being able to form association relationships.

65. The information connection method based on entity information houses according to claim 1, further comprising branch information houses and the headquarters information house of local chamber of commerce being able to form association relationships.

66. The information connection method based on entity information houses according to claim 1, further comprising residential community information houses can comprise their own map information spaces.

67. The information connection method based on entity information houses according to claim 1, further comprising school information houses can comprise their own map information spaces.

68. The information connection method based on entity information houses according to claim 1, further comprising authorized users obtaining target household information houses through inner-maps of residential community information houses, and/or sending information to the target household information houses, and/or entering the target household information houses to operate information.

69. The information connection method based on entity information houses according to claim 1, further comprising the users entering target residential community information houses to operation information through family user groups.

70. The information connection method based on entity information houses according to claim 1, further comprising the users obtaining internal store or activity venue information houses through inner-maps of residential community information houses, and/or entering the internal store or activity venue information houses to operate information, and/or send information to the internal store or activity venue information houses.

71. The information connection method based on entity information houses according to claim 1, further comprising authorized users or non-authorized users chatting and interacting, and/or browsing or commenting or downloading or uploading public or non-public pictures or videos in residential community information houses.

72. The information connection method based on entity information houses according to claim 1, further comprising authorized users or on-site users of residential community information houses uploading pictures or videos to the residential community information houses.

73. The information connection method based on entity information houses according to claim 1, further comprising the users obtaining associated target residential community information houses through police office or police station or community organization or community hospital information houses, and/or sending information to the target residential community information houses, and/or entering the target residential community information houses to operate information.

74. The information connection method based on entity information houses according to claim 1, further comprising the users obtaining associated target residential community information houses through family user groups or police office or police station information houses and sending information to on-site users.

75. The information connection method based on entity information houses according to claim 1, further comprising the users obtaining associated target office building information houses through police office or police station or company information houses, and/or sending information to the target office building information houses, and/or entering the target office building information houses to operate information.

76. The information connection method based on entity information houses according to claim 1, further comprising authorized users or non-authorized users chatting and interacting, and/or browsing or commenting or downloading or uploading public or non-public pictures or videos in office building information houses.

77. The information connection method based on entity information houses according to claim 1, further comprising the users obtaining associated target office building information houses through police office or police station or company information houses, and sending information to on-site users.

78. The information connection method based on entity information houses according to claim 1, further comprising the users obtaining target school information houses through family user groups or alumnus user groups, and/or sending information to the target school information houses, and/or entering the target school information houses to operate information.

79. The information connection method based on entity information houses according to claim 1, further comprising school information houses being able to associate with education management department or organization information houses.

80. The information connection method based on entity information houses according to claim 1, further comprising the users obtaining target school information houses of through police office or police station or education management department information houses, and/or sending information to the target school information houses, and/or entering the target school information houses to operate information.

81. The information connection method based on entity information houses according to claim 1, further comprising the users obtaining target school information houses through family user groups or alumnus user groups or entity information houses, and sending information to on-site users.

82. The information connection method based on entity information houses according to claim 1, further comprising the users obtaining target school information houses through teacher user groups or class student user groups or dormitory user groups or student club user groups, and/or sending information to the target school information houses, and/or entering the target school information houses to operate information.

83. The information connection method based on entity information houses according to claim 1, further comprising the users obtaining target school information houses through teacher user groups or class student user groups or dormitory user groups or student club user groups, and sending information to on-site users.

84. The information connection method based on entity information houses according to claim 1, further comprising the users obtaining target class information houses through family user groups, and/or sending information to the class information houses, and/or entering the class information houses to operate information.

85. The information connection method based on entity information houses according to claim 1, further comprising the users obtaining target teaching department or management department information houses of school through inner-maps of school information houses, and/or sending information to the teaching department or management department information houses, and/or entering the teaching department or management department information houses to operate information.

86. The information connection method based on entity information houses according to claim 1, further comprising authorized users or non-authorized users of schools, obtaining target school information houses through devices positioning or user groups or inner-maps of school information houses or outer-maps, and/or sending information to on-site users, and/or entering the target school information houses to chat and interact and/or browse or comment or download or upload public or non-public pictures or videos or articles.

87. The information connection method based on entity information houses according to claim 1, further comprising authorized users or non-authorized users of schools obtaining canteen or restaurant information houses of target schools through devices positioning or user groups or inner-maps of school information houses or outer-maps, and/or sending information to the canteen or restaurant information houses, and/or entering the canteen or restaurant information houses to operate information.

88. The information connection method based on entity information houses according to claim 1, further comprising the users obtaining canteen or restaurant information houses of target schools through devices positioning or user groups or inner-maps of school information houses or outer-maps, and/or sending information to on-site users, and/or on-site authorized or non-authorized users uploading pictures or videos to the canteen or restaurant information houses or to internal superior information houses of the canteen or restaurant information houses.

89. The information connection method based on entity information houses according to claim 1, further comprising pictures or videos uploaded by users, of canteen or restaurant information houses of schools can be marked on inner-maps or internal-superior-maps or outer-maps, users through selecting target picture or video marks on the maps, and/or being able to browse or comment pictures or videos and/or enter picture or video list information spaces and/or enter the entity information houses.

90. The information connection method based on entity information houses according to claim 1, further comprising authorized users or non-authorized users of schools obtaining target school bulletin board information houses through device positioning or user groups or inner-maps of school information houses or outer-maps, and/or sending information to the bulletin board information houses, and/or entering the bulletin board information houses to operate information.

91. The information connection method based on entity information houses according to claim 1, further comprising the users obtaining target school bulletin board information houses through device positioning or user groups or inner-maps of school information houses or outer-maps, and/or sending information to on-site users, and/or on-site authorized or non-authorized users uploading pictures or videos to the bulletin board information houses or internal superior information houses of the bulletin board information houses.

92. The information connection method based on entity information houses according to claim 1, further comprising pictures or videos uploaded by users, of school bulletin board information houses being marked on inner-maps or internal-superior-maps or outer-maps, users through selecting target picture or video marks on the maps, and/or being able to browse or comment pictures or videos and/or enter picture or video list information spaces and/or enter the entity information houses.

93. The information connection method based on entity information houses according to claim 1, further comprising authorized users or non-authorized users of schools obtaining target school sport field information houses through device positioning or user groups or inner-maps of school information houses or outer-maps, and/or sending information to the sport field information houses, and/or entering the sport field information houses to operate information.

94. The information connection method based on entity information houses according to claim 1, further comprising the users obtaining target school sport field information houses through device positioning or user groups or inner-maps of school information houses or outer-maps, and/or sending information to on-site users, and/or on-site authorized or non-authorized users uploading pictures or videos to the sport field information houses or internal superior information houses of the sport field information houses.

95. The information connection method based on entity information houses according to claim 1, further comprising pictures or videos uploaded by users, of sport field information houses of schools being marked on inner-maps or internal-superior-maps or outer-maps, users through selecting target picture or video marks on the maps, and/or being able to browse or comment pictures or videos and/or enter picture or video list information spaces and/or enter the entity information houses.

96. The information connection method based on entity information houses according to claim 1, further comprising authorized users or non-authorized users of schools obtaining target school library information houses through device positioning or user groups or inner-maps of school information houses or outer-maps, and/or sending information to the library information houses, and/or entering the library information houses to operate information.

97. The information connection method based on entity information houses according to claim 1, further comprising the users obtaining target school library information houses through device positioning or user groups or inner-maps of school information houses or outer-maps, and/or sending information to on-site users, and/or on-site authorized users or non-authorized users uploading pictures or videos to the library information houses or to the internal superior information houses of the library information houses.

98. The information connection method based on entity information houses according to claim 1, further comprising pictures or videos uploaded by users, of library information houses of schools being marked on inner-maps or internal-superior-maps or outer-maps, users through selecting target picture or video marks on the maps, and/or being able to browse or comment pictures or videos and/or enter picture or video list information spaces and/or enter the entity information houses.

99. The information connection method based on entity information houses according to claim 1, further comprising the users obtaining target school dormitory information houses through device positioning or user groups or inner-maps of school information houses, and/or sending information to the dormitory information houses, and/or entering the dormitory information houses to operate information.

100. The information connection method based on entity information houses according to claim 1, further comprising the users obtaining target school dormitory information houses through device positioning or user groups or inner-maps of school information houses or outer-maps, and/or sending information to on-site users, and/or on-site authorized users or non-authorized users uploading pictures or videos to the dormitory information houses or to internal superior information houses of the dormitory information houses.

101. The information connection method based on entity information houses according to claim 1, further comprising pictures or videos uploaded by users, of school dormitory information houses being marked on inner-maps or internal-superior-maps or outer-maps, users through selecting target picture or video marks on maps, and/or being able to browse or comment pictures or videos and/or enter picture or video list information spaces and/or enter the entity information houses.

102. The information connection method based on entity information houses according to claim 1, further comprising the users obtaining target school teaching building or classroom information houses through device positioning or user groups or inner-maps of school information houses or outer-maps, and/or sending information to the teaching building or classroom information houses, and/or entering the teaching building or classroom information houses to operate information.

103. The information connection method based on entity information houses according to claim 1, further comprising the users obtaining target teaching building or classroom information houses through devices positioning or user groups or inner-maps of school information houses or outer-maps, and/or sending information to on-site users, and/or on-site authorized or non-authorized users uploading pictures or videos to the teaching building or classroom information houses or to internal superior information houses of the teaching building or classroom information houses.

104. The information connection method based on entity information houses according to claim 1, further comprising pictures or videos uploaded by users, of teaching building or classroom information houses being marked on inner-maps or internal-superior-maps or outer-maps, users through selecting target picture or video marks on maps, and/or being able to browse or comment pictures or videos and/or enter picture or video list information spaces and/or enter the entity information houses.

105. The information connection method based on entity information houses according to claim 1, further comprising authorized users or non-authorized users of schools obtaining target school scenic spot or square information houses through device positioning or inner-maps of school information houses or outer-maps, and/or sending information to the scenic spot or square information houses, and/or entering the scenic spot or square information houses to operate information.

106. The information connection method based on entity information houses according to claim 1, further comprising the users obtaining target school scenic spot or square information houses through device positioning or user groups or inner-maps of school information houses or outer-maps, and/or sending information to on-site users, and/or on-site authorized or non-authorized users uploading pictures or videos to the scenic spot or square information houses or to internal superior information houses of the scenic spot or square information houses.

107. The information connection method based on entity information houses according to claim 1, further comprising pictures or videos uploaded by users, of school scenic spot or square information houses being marked on inner-maps or internal-superior-maps or outer-maps, users through selecting target picture or video marks on maps, and/or being able to browse or comment pictures or videos and/or enter picture or video list information spaces and/or enter the entity information houses.

108. The information connection method based on entity information houses according to claim 1, further comprising authorized users or non-authorized users of schools obtaining target school road or road section information houses through device positioning or user groups or inner-maps of school information houses or outer-maps, and/or sending information to the road or road section information houses, and/or entering the road or road section information houses to operate information.

109. The information connection method based on entity information houses according to claim 1, further comprising the users obtaining target school road or road section information houses through devices positioning or user groups or inner-maps of school information houses or outer-maps, and/or sending information to on-site users, and/or on-site authorized users or non-authorized users uploading pictures or videos to the road or road section information houses or to internal superior information houses of the road or road section information houses.

110. The information connection method based on entity information houses according to claim 1, further comprising pictures or videos uploaded by users, of school road or road section information houses being marked on inner-maps or internal-superior-maps or outer-maps, users through selecting target picture or video marks on the maps, and/or being able to browse or comment pictures or videos and/or enter picture or video list information spaces and/or enter the entity information houses.

111. The information connection method based on entity information houses according to claim 1, further comprising authorized users or non-authorized users of schools obtaining target school area information houses through device positioning or user groups or inner-maps of school information houses or outer-maps, and/or sending information to the area information houses, and/or entering the area information houses to operate information.

112. The information connection method based on entity information houses according to claim 1, further comprising users obtaining target school area information houses through devices positioning or user groups or inner-maps of school information houses or outer-maps, and/or sending information to on-site users, and/or on-site authorized users or non-authorized users uploading pictures or videos to the area information houses or to internal superior information houses of the area information houses.

113. The information connection method based on entity information houses according to claim 1, further comprising pictures or videos uploaded by users, of school area information houses being marked on inner-maps or internal-superior-maps or outer-maps, users through selecting target picture or video marks on the maps, and/or being able to browse or comment pictures or videos and/or enter picture or video list information spaces and/or enter the entity information houses.

114. The information connection method based on entity information houses according to claim 1, further comprising authorized users or non-authorized users of schools obtaining target school store information houses through devices positioning or user groups or inner-maps of school information houses or outer-maps, and/or sending information to the store information houses, and/or entering the store information houses to operate information.

115. The information connection method based on entity information houses according to claim 1, further comprising the users obtaining target school store information houses through devices positioning or user groups or inner-maps of school information houses or outer-maps, and/or sending information to on-site users, and/or on-site authorized users or non-authorized users uploading pictures or videos to the store information houses or to internal superior information houses of the store information houses.

116. The information connection method based on entity information houses according to claim 1, further comprising pictures or videos uploaded by users, of school store information houses being marked on inner-maps or internal-superior-maps or outer-maps, users through selecting target picture or video marks on the maps, and/or being able to browse or comment pictures or videos and/or enter picture or video list information spaces and/or enter the entity information houses.

117. The information connection method based on entity information houses according to claim 1, further comprising authorized users or non-authorized users of schools obtaining target school hospital information houses through device positioning or user groups or inner-maps of school information houses or outer-maps, and/or sending information to the hospital information houses, and/or entering the hospital information houses to operate information.

118. The information connection method based on entity information houses according to claim 1, further comprising authorized users or non-authorized users obtaining target company or factory information houses through user groups or device positioning or inner-maps of company or factory information houses or outer-maps, and/or sending information to on-site users, and/or entering the company or factory information houses to chat and interact, and/or browse or comment or download or upload public or non-public pictures or videos or articles.

119. The information connection method based on entity information houses according to claim 1, further comprising authorized users or non-authorized users of companies or factories obtaining target company or factory activity venue information houses through device positioning or inner-maps of company or factory information houses or outer-maps, and/or sending information to on-site users, and/or entering the activity venue information houses to chat and interact, and/or browse or comment or download or upload public or non-public pictures or videos or articles.

120. The information connection method based on entity information houses according to claim 1, further comprising authorized users or non-authorized users of companies or factories obtaining target company or factory activity venue information houses through the user groups or device positioning or inner-maps of company or factory information houses or outer-maps, and/or sending information to on-site users, and/or on-site authorized users or non-authorized users uploading pictures or videos to the activity venue information houses or to internal superior information houses of the activity venue information houses.

121. The information connection method based on entity information houses according to claim 1, further comprising pictures or videos uploaded by users, of company or factory activity venue information houses being marked on inner-maps or internal-superior-maps or outer-maps, users through selecting target picture or video marks on the maps, and/or being able to browse or comment pictures or videos and/or enter picture or video list information spaces and/or enter the entity information houses.

122. The information connection method based on entity information houses according to claim 1, further comprising authorized users or non-authorized users of companies or factories obtaining target canteen or restaurant information houses through user groups or device positioning or inner-maps of company or factory information houses or outer-maps, and/or sending information to on-site users, and/or entering the canteen or restaurant information houses to chat and interact, and/or browse or comment or download or upload public or non-public pictures or videos or articles.

123. The information connection method based on entity information houses according to claim 1, further comprising the users obtaining target canteen or restaurant information houses of companies or factories through device positioning or user groups or inner-maps of the company or factory information houses or outer-maps, and/or sending information to on-site users, and/or on-site authorized users or non-authorized users uploading pictures or videos to the canteen or restaurant information houses or to internal superior information houses of the canteen or restaurant information houses.

124. The information connection method based on entity information houses according to claim 1, further comprising pictures or videos uploaded by users, of canteen or restaurant information houses of companies or factories being marked on inner-maps or internal-superior-maps or outer-maps, users through selecting target picture or video marks on the maps, and/or being able to browse or comment pictures or videos and/or enter picture or video list information spaces and/or enter the entity information houses.

125. The information connection method based on entity information houses according to claim 1, further comprising authorized users or non-authorized users of companies or factories obtaining target office area or office building or office information houses through device positioning or inner-maps of company or factory information houses or outer-maps, and/or sending information to on-site users, and/or entering the office area or office building or office information houses to chat and interact, and/or browse or comment or download or upload public or non-public pictures or videos or articles.

126. The information connection method based on entity information houses according to claim 1, further comprising the users obtaining target office area or office building or office information houses of companies or factories through device positioning or inner-maps of company or factory information houses or outer-maps, and/or sending information to on-site users, and/or on-site authorized users or non-authorized users uploading pictures or videos to the office area or office building or office information houses or to internal superior information houses of the office area or office building or office information houses.

127. The information connection method based on entity information houses according to claim 1, further comprising pictures or videos uploaded by users, of office area or office building or office information houses of companies or factories being marked on inner-maps or internal-superior-maps or outer-maps, users through selecting target picture or video marks on the maps, and/or being able to browse or comment pictures or videos and/or enter picture or video list information spaces and/or enter the entity information houses.

128. The information connection method based on entity information houses according to claim 1, further comprising the users obtaining target street information houses through device positioning or inner-maps of street information houses or outer-maps, and/or sending information to on-site users, and/or entering the street information houses to chat and interact, and/or browse or comment or download or upload pictures or videos or articles.

129. The information connection method based on entity information houses according to claim 1, further comprising users obtaining target street information houses through device positioning or inner-maps of street information houses or outer-maps, and/or sending information to on-site users, and/or on-site or off-site users uploading pictures or videos or articles to the street information houses or to internal superior information houses of the street information houses.

130. The information connection method based on entity information houses according to claim 1, further comprising pictures or videos uploaded by users, of street information houses being marked on inner-maps or internal-superior-maps or outer-maps, users through selecting target picture or video marks on the maps, and/or being able to browse or comment pictures or videos and/or enter picture or video list information spaces and/or enter the entity information houses.

131. The information connection method based on entity information houses according to claim 1, further comprising the users obtaining target city area or block information houses through devices positioning or inner-maps of city or area or block information houses or outer-maps, and/or sending information to on-site users, and/or entering the area or block information houses to chat and interact, and/or browse or comment or download or upload pictures or videos or articles.

132. The information connection method based on entity information houses according to claim 1, further comprising the users obtaining target city area or block information houses through devices positioning or inner-maps of city or area or block information houses or outer-maps, and/or sending information to on-site users, and/or on-site users or off-site users uploading pictures or videos or articles to the area or block information houses or to internal superior information houses of the area or block information houses.

133. The information connection method based on entity information houses according to claim 1, further comprising pictures or videos uploaded by users, of city area or block information houses being marked on inner-maps or internal-superior-maps or outer-maps, users through selecting target picture or video marks on the maps, and/or being able to browse or comment pictures or videos and/or enter picture or video list information spaces and/or enter the entity information houses.

134. The information connection method based on entity information houses according to claim 1, further comprising the users obtaining target road or road section information houses through device positioning or inner-maps of road or road section information houses or outer-maps, and/or sending information to on-site users, and/or entering the road or road section information houses to chat and interact, and/or browse or comment or download or upload pictures or videos or articles.

135. The information connection method based on entity information houses according to claim 1, further comprising the users obtaining target road or road section information houses through devices positioning or inner-maps of road or road section information houses or outer-maps, and/or sending information to on-site users, and/or on-site users or off-site users uploading pictures or videos or articles to the road or road section information houses or to internal superior information houses of the road or road section information houses.

136. The information connection method based on entity information houses according to claim 1, further comprising pictures or videos uploaded by users, of road or road section information houses being marked on inner-maps or internal-superior-maps or outer-maps, users through selecting target picture or video marks on the maps, and/or being able to browse or comment pictures or videos and/or enter picture or video list information spaces and/or enter the entity information houses.

137. The information connection method based on entity information houses according to claim 1, further comprising the users obtaining target television station or station or airport or film base or amusement park or square or park or scenic area or scenic spot information houses through device positioning or inner-maps of television station or station or airport or film base or amusement park or square or park or scenic area or scenic spot information houses or outer-maps, and/or sending information to on-site users, and/or entering the television station or station or airport or film base or amusement park or square or park or scenic area or scenic spot information houses to chat and interact, and/or browse or comment or download or upload picture or videos or articles.

138. The information connection method based on entity information houses according to claim 1, further comprising the users obtaining target information houses through device positioning or inner-maps of television station or station or airport or film base or amusement park or square or park or scenic area or scenic spot information houses or outer-maps, and/or sending information to on-site users, and/or the on-site users or off-site users uploading pictures or videos or articles to the target information houses or to internal superior information houses of the target information houses.

139. The information connection method based on entity information houses according to claim 1, further comprising pictures or videos uploaded by users, of television station or station or airport or film base or amusement park or square or park or scenic area or scenic spot information houses being marked on inner-maps or internal-superior-maps or outer-maps, users through selecting target picture or video marks on maps, and/or being able to browse or comment picture or videos and/or enter picture or video list information spaces and/or enter the entity information houses.

140. The information connection method based on entity information houses according to claim 1, further comprising the users obtaining target subway line or line section information houses through device positioning or inner-maps of subway line or line section information houses or outer-maps, and/or sending information to on-site users, and/or entering the subway line or line section information houses to chat and interact, and/or browse or comment or download or upload pictures or videos or articles.

141. The information connection method based on entity information houses according to claim 1, further comprising the users obtaining target subway line or line section information houses through device positioning or inner-maps of subway line or line section information houses or outer-maps, and/or sending information to on-site users, and/or the on-site users or off-site users uploading pictures or videos or articles to the subway line or line section information houses or to internal superior information houses of the subway line or line section information houses.

142. The information connection method based on entity information houses according to claim 1, further comprising pictures or videos uploaded by users, of subway line or line section information houses being marked on inner-maps or internal-superior-maps or outer-maps, users through selecting target picture or video marks on maps, and/or being able to browse or comment pictures or videos and/or enter picture or video list information spaces and/or enter the entity information houses.

143. The information connection method based on entity information houses according to claim 1, further comprising the users obtaining target hospital information houses through device positioning or user groups or inner-maps of hospital information houses or outer-maps, and sending information to on-site users, and/or entering the hospital information houses to chat and interact, and/or browse or comment or download or upload pictures or videos or articles.

144. The information connection method based on entity information houses according to claim 1, further comprising the users obtaining target hospital information houses through device positioning or user groups or inner-maps of the hospital information houses or outer-maps, and/or sending information to on-site users, and/or the on-site users or off-site users uploading pictures or videos or articles to the hospital information houses or to internal superior information houses of the hospital information houses.

145. The information connection method based on entity information houses according to claim 1, further comprising pictures or videos uploaded by users, of hospital information houses being marked on inner-maps or internal-superior-maps or outer-maps, users through selecting target picture or video marks on the maps, and/or being able to browse or comment pictures or videos and/or enter picture or video list information spaces and/or enter the entity information houses.

146. The information connection method based on entity information houses according to claim 1, further comprising the users obtaining target mountain or river information houses through device positioning or inner-maps of mountain or river information houses or outer-maps, and/or sending information to on-site users, and/or entering the mountain or river information houses to chat and interact, and/or browse or comment or download or upload pictures or videos or articles.

147. The information connection method based on entity information houses according to claim 1, further comprising the users obtaining target mountain or river information houses through device positioning or inner-maps of mountain or river information houses or outer-maps, and/or sending information to on-site users, and/or the on-site users or off-site users uploading pictures or videos or articles to the mountain or river information houses or to internal superior information houses of the mountain or river information houses.

148. The information connection method based on entity information houses according to claim 1, further comprising pictures or videos uploaded by users, of mountain or river information houses being marked on inner-maps or internal-superior-maps or outer-maps, users through selecting target picture or video marks on the maps, and/or being able to browse or comment pictures or videos and/or enter picture or video list information spaces and/or enter the entity information houses.

149. The information connection method based on entity information houses according to claim 1, further comprising the users obtaining target theater or cinema or bar or dance hall information houses through device positioning or inner-maps of theater or cinema or bar or dance hall information houses or outer-maps, and/or sending information to on-site users, and/or entering the mountain or river information houses to chat and interact, and/or browse or comment or download or upload pictures or videos or articles.

150. The information connection method based on entity information houses according to claim 1, further comprising the users obtaining target theater or cinema or bar or dance hall information houses through devices positioning or inner-maps of theater or bar or dance hall information houses or outer-maps, and/or sending information to on-site users, and/or the on-site users or off-site users uploading pictures or videos or article to the theater or cinema or bar or dance hall information houses or to their internal superior information houses.

151. The information connection method based on entity information houses according to claim 1, further comprising pictures or videos uploaded by users, of theater or cinema or bar or dance hall information houses being marked on inner-maps or internal-superior-maps or outer-maps, users through selecting target picture or video marks on maps, and/or being able to browse or comment pictures or videos and/or enter picture or video list information spaces and/or enter the entity information houses.

152. The information connection method based on entity information houses according to claim 1, further comprising the users obtaining target rally or temple fair or marathon or sports meeting or bicycle race or ball game or concert or opening ceremony or graduation ceremony or wedding information houses by device positioning or inner-maps of rally or temple fair or marathon or sports meeting or bicycle race or ball game or concert or opening ceremony or graduation ceremony or wedding information houses or outer-maps, and/or sending information to on-site users, and/or entering the rally or temple fair or marathon or sports meeting or bicycle race or ball game or concert or opening ceremony or graduation ceremony or wedding information houses to chat and interact, and/or browse or comment or download or upload pictures or videos or articles.

153. The information connection method based on entity information houses according to claim 1, further comprising the users obtaining target rally or temple fair or marathon or sports meeting or bicycle race or ball game or concert or opening ceremony or graduation ceremony or wedding information houses through device positioning or inner-maps of rally or temple fair or marathon or sports meeting and/or bicycle race or ball game and/or concert or opening ceremony or graduation ceremony or wedding information houses or outer-maps, and/or sending information to on-site users, and/or the on-site users or off-site users uploading pictures or videos or articles to the rally or temple fair or marathon or sports meeting or bicycle race or ball game or concert or opening ceremony or graduation ceremony or wedding information houses or to internal superior information houses of the rally or temple fair or marathon or sports meeting or bicycle race or ball game or concert or opening ceremony or graduation ceremony or wedding information houses.

154. The information connection method based on entity information houses according to claim 1, further comprising pictures or videos uploaded by users, of rally or temple fair or marathon or sports meeting or bicycle race or ball game or concert or opening ceremony or graduation ceremony or wedding information houses being marked on inner-maps or internal-superior-maps or outer-maps, users through selecting target picture or video marks on the maps, and/or being able to browse or comment pictures or videos and/or enter picture or video list information spaces and/or enter the entity information houses.

155. The information connection method based on entity information houses according to claim 1, further comprising the users obtaining target earthquake or fire disaster or wind disaster or flood or accident or hot event information houses through device positioning or inner-maps of earthquake or fire disaster or wind disaster or flood or accident or hot event information houses or outer-maps, and/or sending information to on-site users, and/or entering the earthquake or fire disaster or wind disaster or flood or accident or hot event information houses to chat and interact, and/or browse or comment or download or upload pictures or videos or articles.

156. The information connection method based on entity information houses according to claim 1, further comprising the users obtaining target earthquake or fire disaster or wind disaster or flood or accident or hot event information houses through device positioning or inner-maps of earthquake or fire disaster or wind disaster or flood or accident or hot event information houses or outer-maps, and/or sending information to on-site users, and/or the on-site users or off-site users uploading pictures or videos or articles to the earthquake or fire disaster or wind disaster or flood or accident or hot event information houses or to internal superior information houses of the earthquake or fire disaster or wind disaster or flood or accident or hot event information houses.

157. The information connection method based on entity information houses according to claim 1, further comprising pictures or videos uploaded by users, of earthquake or fire disaster or wind disaster or flood or accident or hot event information houses being marked on inner-maps or internal-superior-maps or outer-maps, users through selecting target pictures or video marks on the maps, and/or being able to browse or comment pictures or videos and/or enter picture or video list information spaces and/or enter the entity information houses.

158. The information connection method based on entity information houses according to claim 1, further comprising the users obtaining associated target community organization or police office or police station or community hospital information houses through residential community information houses, and/or sending information to the community organization or police office or police station or community hospital information houses, and/or entering the community organization or police office or police station or community hospital information houses to operate information.

159. The information connection method based on entity information houses according to claim 1, further comprising the users obtaining associated target community organization or police office or police station or community hospital information houses through company or factory or office building information houses, and/or sending information to the community organization or police office or police station or community hospital information houses, and/or entering the community organization or police office or police station or community hospital information houses to operate information.

160. The information connection method based on entity information houses according to claim 1, further comprising street or block information houses being able to associate with community organization or police office or police station information houses.

161. The information connection method based on entity information houses according to claim 1, further comprising ball game fan user groups or sport fan user groups being able to associate with ball game fan association or stadium or gymnasium or sport venue information houses.

162. The information connection method based on entity information houses according to claim 1, further comprising two relative family user groups being able to form an association relationship.

163. The information connection method based on entity information houses according to claim 1, further comprising alumnus user groups being able to form association relationships.

164. The information connection method based on entity information houses according to claim 1, further comprising family user groups and medical staff user groups being able to be in a same user group.

165. The information connection method based on entity information houses according to claim 1, further comprising family user groups and teacher user groups being able to be in a same user group.

166. The information connection method based on entity information houses according to claim 1, further comprising class student user groups and teacher user groups being able to be in a same user group.

167. An information connection apparatus based on entity information houses, comprising a serving end and a user end, the serving end being installed on a back-end server, the user terminal being installed on a notebook, a desktop computer, or a handheld equipment, when the information connection device constituted by the serving end and the user end operates, the information connection method as claimed in claim 1 is implemented.
